(19) United States
(12) Patent Application Publication
(10) Pub. No.: US 2019/0347724 A1
(43) Pub. Date: Nov. 14, 2019

(54) TRADABLE OPTIONS FOR A PRODUCT, A COMMODITY, A SERVICE, OR A SPECIFIED TAX RATE

(71) Applicant: Mark Joseph Krupp, Hendersonville, TN (US)

(72) Inventor: Mark Joseph Krupp, Hendersonville, TN (US)

(21) Appl. No.: 15/976,325

(22) Filed: May 10, 2018

(51) Int. Cl. G06Q 40/04; G06Q 40/00

(52) U.S. Cl. CPC G06Q 40/04; G06Q 20/20; G06Q 40/10

(57) ABSTRACT

Today, options are mainly used for speculation and hedging against losses in investment portfolios. There is limited use of options in the general economy because options which can only be exercised once are impractical for fulfilling everyday purchases of products, commodities, and/or services. Another reason options aren't used in the general economy, is that they are not fulfilled at the point of purchase. Currently, options are mainly fulfilled by the Options Clearing Corporation. The call options described herein are for use in the general economy by permitting exercise and/or fulfillment one or more times, at point-of-sale systems, e-commerce sites, seller's selling software, and/or by government software. Call options described herein may be used to control costs and/or taxes for a specified period. Because these call options can be exercised more than once, they can be divided and/or shared among participants in a co-op call option offering.

### CROSS-REFERENCE TO RELATED APPLICATIONS

The present application is based on and claims the benefit of U.S. Provisional Patent Application Ser. No. 62/624,306, filed Jan. 31, 2018, entitled “System for writing, exchanging, exercising and fulfilling call option contracts that grant a buyer an agreed-upon price or a fixed discount during a specified amount of time” and U.S. Provisional Patent Application Ser. No. 62/639,060, filed Mar. 6, 2018, entitled “Call option that gives the buyer the right, but not the obligation to exercise and fulfill the option contract at least one time, between a specified start date and expiry date, on a point-of-sale system, on an e-commerce website, by seller's ordering software, or government software, to buy the underlying asset for a specified price that is either a product, a commodity, a service, or a specified tax rate,” all of which are hereby incorporated by reference in their entirety.

### TECHNICAL FIELD

The subject matter described herein related to call options used in the general economy that can be exercised, at least one time, and are exercised and fulfilled in stores by point-of-sale systems, by e-commerce sites, by seller's ordering software and/or buyer's ordering software and government software that calculates and charges various taxes.

### BACKGROUND

Call option contracts are a type of derivative that grants the buyer or holder of the option the right, but not the obligation to buy an underlying asset at a set price on or before a certain date. Option contracts can be bought or sold with multiple expiration dates. The underlying asset for an option is typically a stock or stock index. Other underlying assets for options are land, bonds, foreign currencies, commodities, and other derivatives.

When a holder of a call option contract purchases the underlying asset represented by the option, it is called exercising the option. Currently, a holder of an option can only exercise it once. After a holder exercises their option, all of the underlying assets are bought and paid for, and the option is expired.

Currently, the Options Clearing Corporation (OCC) fulfills most call option contracts. All of the options exchanges (CBOE, Philly Exchange, Pacific exchange, and others) are charter members of the OCC.

Currently, the investment industry is the primary user of options. One common use of options is for financial speculation. When an investor buys a call option, they pay a small premium in exchange for the right but not the obligation to buy such things as shares of stock, shares of a stock index or commodity contracts at a fixed price by certain expiry date. If the underlying asset goes up to the strike price before the expiry date of the option, the option holder can sell them or exercise them for a profit. If the underlying asset fails to reach the strike price, the option expires and becomes worthless. The advantage of speculating with call options is that a speculator can make a leveraged bet on a direction of an underlying asset without buying it for a much higher price. The disadvantage is that the call option can expire entirely worthless.

Another popular reason investors use options is for hedging against a loss in their investments. An investor can ensure against loss by buying put options with underlying assets that are the same as what is the investment they are meant to protect. A put option gives a holder the right but not the obligation to sell an underlying asset at a set price until the contract expires. Therefore, the value of a put option increases if the share price of the underlying asset declines below the set price in the option. Since the underlying assets of the put option are the same as the assets they are protecting, they offset any losses if the investment declines below the set price in the option. Thus, with a protective put strategy, an investor can enjoy unlimited profit potential from appreciation in their investments (less the cost of the put options) while getting protection against a decline by being able to close out their investment positions at levels set by the put option contract.

### BRIEF SUMMARY

In accordance with certain aspects described herein, two new types of options were designed specifically for use in the general economy. One of these options may be called a “retail call option.” The other option described herein may be called a “government-sponsored call option.”

In accordance with certain aspects described herein, a retail call option gives the holder of the call option the right, but not the obligation, to buy the underlying asset that is a product, commodity, service or some combination thereof for a specified price, at least one time between a specified start date and a specified expiry date. An exchange that may be called the “Retail Options Exchange” may be used for writing, bidding, and/or selling retail call options. Retail call options may be exercised by the option holder and fulfilled by the option writer by systems incorporated in or used in conjunction with point-of-sale systems, software on e-commerce websites and/or seller's ordering software.

In accordance with certain aspects described herein, a government-sponsored call option gives the holder of the call option the right, but not the obligation, to exercise and have a government-sponsored call option fulfilled at least one time, between a specified start date and a specified expiry date, in order to receive the underlying asset that is a specified tax rate. One type of government-sponsored call option may be used to specify a property tax rate for a specified amount of time. Another type of government-sponsored call option may specify an income tax rate during a stated start date and expiry date. The third type of government-sponsored call option may grant the holder a specified sales tax and/or value-added tax on a set maximum total value of the product, commodity, and/or service for a specified period. The fourth type of government-sponsored call option may grant the holder a specified customs duty tax and/or excise duty tax on particular goods for a stipulated maximum total number of goods for a specified time.

In accordance with certain aspects described herein, an exchange that may be called a “Government Options Exchange,” may be used for writing and selling government-sponsored call options.

In accordance with certain aspects described herein, the vast majority of government-sponsored call options may be exercised and fulfilled by software used by government agencies. Government-sponsored call options that grant the holder a specified sales tax and/or value-added tax, on the other hand, options may be exercised by the option holder and fulfilled by the option writer by systems incorporated in or used in conjunction with point-of-sale systems, software on e-commerce websites and/or seller's ordering software.

In accordance with certain aspects described herein, one use of a retail call option may be to promote price stability down an economic chain, spanning from production to retail customers. With retail call options, wholesalers and distributors may more accurately budget their overall expenses and hedge against price increases in products and/or commodities by purchasing retail call options. In turn, retailers may use retail call option contracts to either reduce their inventory costs for products and/or commodities or hedge against price increases in these items from their wholesale and distributor suppliers. Retail customers acting individually or organized into co-ops may use retail call options to set a maximum price for products, commodities and/or services purchased in retail stores, in service outlets, on e-commerce sites and/or by seller's ordering software.

In accordance with certain aspects described herein, one use of government-sponsored call options may be to offer government agencies an interest-free alternative to raising money. Currently, government agencies may raise money by selling interest-bearing bonds. Governments then pay back the interest and principal to bondholders with money collected from taxes and fees. Alternatively, government agencies can raise capital without incurring interest cost by selling government-sponsored call option contracts sold on an exchange. The second purpose of government-sponsored call options may be to grant the option holder a specified tax rate between a stated start date and an expiry date.

In accordance with certain aspects described herein, the call options described herein were modified significantly from other types of options used currently, to adapt their use in the general economy.

In accordance with certain aspects described herein, one unique feature that was added to retail call option contracts and government-sponsored call option contracts, to adapt their use in the general economy, was that they may enable a holder to exercise them one or more times. In contrast, other types of option contracts can be exercised only once.

In accordance with certain aspects described herein, another unique modification that was added to retail call option contracts and government-sponsored call option contracts, to make them better suited for use in the general economy, was the feature that they may not automatically expire when exercised. In contrast, conventional call options immediately expire when exercised.

In accordance with certain aspects described herein, the exercise and fulfillment of retail call option contracts and government-sponsored call option contracts is also unique. Retail call option contracts and government-sponsored call option contracts may be exercised and/or settled at point-of-sale systems, e-commerce sites, by a seller's ordering software or by government agency software to adapt their use in the general economy.

Currently, the Options Clearing Corporation clears almost all options written. In contrast, holders of retail call options may be exercised by the option holder and fulfilled by point-of-sale systems in stores, by software used by e-commerce websites and/or by seller's ordering software. Software used by government agencies may fulfill most government-sponsored call options that are exercised by option holders. Government-sponsored call options that grant the holder the right, but not the obligation to exercise them to get a specified sales tax and/or value-added tax, on the other hand, may be exercised by the option holder and fulfilled by the option writer by systems incorporated in or used in conjunction with point-of-sale systems, software on e-commerce websites and/or seller's ordering software.

In accordance with certain aspects described herein, another unique feature of retail call options that makes them well suited for use in the general economy is their use for setting a maximum price when purchasing a product, commodity, service or some combination thereof. In contrast, the booklet provided by the Options Clearing Corporation (OOC) states that options are currently available for four types of underlying interests: equity securities, stock indexes, government debt securities and foreign currencies.

In accordance with certain aspects described herein, another feature of retail call options that makes them unique from options in current use is that they may be fractionated into shares and divided among participant buyers organized in a co-op. Fractionating of a retail call option into retail call option shares is made possible when it can be exercised and fulfilled more than one time. Fractionating an existing call option into shares for a co-op call option offering may be at the discretion of the option writer that wrote the original call option.

One of the obstacles to getting smaller retailers or retail customers involved in a Retail Options Exchange is that individually they may not purchase sufficient quantities of a particular product, commodity, and/or service to warrant buying a retail call option contract (e.g., because a retail call option contract may be for 100, 1,000, 10,000, or another number of items). To overcome this obstacle, the Retail Options Exchange may facilitate the creation of co-op call option offerings that offer shares of an existing call option.

In accordance with certain aspects described herein, a financial derivative that may be called a retail call option gives the buyer the right, but not the obligation to buy the underlying asset that may be a product, commodity, service or some combination thereof, for a specified price, one or more times within a specified start time and an expiry date.

In accordance with certain aspects described herein, the following are features of every retail call option. The option indicates the name of the product, commodity, service or some combination thereof that is the underlying asset of the retail call option. The retail call option also has a description of the units of measurement of the product, commodity, service or some combination thereof that is the underlying asset. The name of the company that is providing the product, commodity and/or service according to the agreement is also included in the option contract. Also included in the call option contract is the specified price per unit of the underlying asset, a start date and an expiry date.

In accordance with certain aspects described herein, the following are optional features of retail call options. An option writer may specify the maximum number retail call options offered for bid on the exchange. Another optional feature is that a retail option contract may specify a minimum number of units of product, commodity and/or service purchased every time the call option is exercised. In addition, the writer of the retail call option may stipulate a maximum number of units of product, commodity and/or service that the option writer fulfills with the call option. Writers of retail call options may also limit their use to persons or companies with wholesale and/or retail licenses only. A retail call option contract can stipulate whether it can or cannot be resold on an exchange.

In accordance with certain aspects described herein, retail call option contracts may be written, sold, resold and/or requested on a membership website that may be called the “Retail Options Exchange.” The Retail Options Exchange website may have two or more portals. One of these portals may be restricted to licensed option writers only. Another portal on the Retail Options Exchange website may be for companies and/or persons that want to buy, sell, and/or request retail call options. Security features such as distributed digital ledger technology may be used to inhibit hacking, alteration, and/or loss of option contract information and financial information.

In accordance with certain aspects described herein, producers, wholesalers, and/or retailers (e.g., option writers) may fill out an application and/or pay a licensing fee to obtain a license to write retail option bids for the Retail Options Exchange. Companies may provide the following information to obtain a license to write call options and post them for sale on the exchange: name, address, e-mail address, phone number, financial payment method (e.g., credit card, PayPal®, debit card, etc.) for paying fees and/or for purchasing options, method for receiving payment for selling existing options, notification preferences (e.g., text and/or e-mail), a list of products, commodities, and/or services they intend to write call option contracts and indicate a region in which the company conducts business.

In accordance with certain aspects described herein, the restricted portal for option writers may provide pages to accomplish various tasks. One page that may be provided to option writers would be for reviewing existing option contracts. Another page may be for viewing requested call option contracts for products, commodities, and/or services. A section on both of these pages may be used to write new call option bids and/or for submitting them to the Retail Options Exchange. An additional feature of these pages may include ways to initiate contact with option holders and/or persons requesting option bids.

In accordance with certain aspects described herein, a page may also be provided for managing an option writer's membership. On this page, option writers may indicate their notification preferences (e.g., text and/or e-mail). Option writers may also set up a method for electronically paying their fees and/or set up how they want to receive payment for selling retail options.

In accordance with certain aspects described herein, another page may be used by option writers for managing their exchange license. On this page, the option writer may list types of products, commodities, and/or services they intend to write options for. The option writer may be charged a fee whenever they add an item to this list because the exchange must verify they are a verified seller.

In accordance with certain aspects described herein, option writers may also have full access to the Retail Options Exchange. One reason why option writers view option bids on the exchange may be to check out the option bids offered by their competitors.

In accordance with certain aspects described herein, another portal on the Retail Options Exchange website may be for companies and/or persons that want to buy, sell, and/or request retail call options. A person may be required to become a member of the Retail Options Exchange to get access to the Retail Options Exchange. The Retail Options Exchange may give a free trial membership to new users. At the option of the Retail Options Exchange, customer memberships may remain free or extended for a nominal fee after a free trial period has expired.

In accordance with certain aspects described herein, companies and/or persons that want to buy, sell, resell and/or request retail call options may provide certain information to obtain membership on the Retail Options Exchange: name, address, e-mail address, phone number, financial payment method (e.g., credit card, PayPal®, debit card, etc.), method for receiving payment for selling existing options, how they want notifications to be sent (e.g., text and/or e-mail).

In accordance with certain aspects described herein, companies and/or persons that want to buy, sell, and/or request retail call options may also indicate in their application for membership whether they want automatic exercise and fulfillment of their retail call options. If a company or person chooses this option, their retail call option is exercised and fulfilled automatically in response to a seller's price for a unit of an underlying asset represented by their options that is higher than a specified price in their call option contracts. If an option holder chooses not to automatically exercise and fulfill their retail call option contracts, the option holder may be required to go through a verification process at a time in which the option holder exercises their call options.

In accordance with certain aspects described herein, the portal for companies and/or persons that want to buy, sell, and/or request retail call options may have a page for reviewing their existing retail call option contracts. This page may also be used to put their options up for sale on the Retail Options Exchange. A section of this page, separate pages and/or pop-up boxes may be provided for contacting option writers of their call option contracts, and/or for writing and submitting requests for call option bids to option writers on the Retail Options Exchange.

In accordance with certain aspects described herein, the portal for companies and/or persons that want to buy, sell, and/or request retail call options may also include a page to view the retail call options that they have listed on the Retail Options Exchange for sale. On this page, the user may also remove an option for sale and/or return it to the user's list of active options.

In accordance with certain aspects described herein, the portal for companies and/or persons that want to buy, sell, and/or request retail call options may also have a page for searching, selecting, and/or purchasing one or more shares of a co-op retail option offering. Co-op retail call option shares are created from fractionating an existing retail call option. This page may also be used to initiate creation of a new co-op retail option offering.

In accordance with certain aspects described herein, an exchange website may have a page for searching and/or for selecting an existing call option to be used for creating a new co-op call option offering. Such a search page may only display call options that permit division and placement into a co-op option offering. After selecting an option for creating a co-op option offer, the website may navigate to another page for indicating how to divide the option into shares and for selecting a closing date. This page may also be used to send the co-op option offering to the exchange to obtain participants.

In accordance with certain aspects described herein, the purchase of a call option that is an underlying asset in a co-op call option offering may not occur until there are sufficient pledges to buy all shares of the call option and every participant pays what they pledged. Participants in a co-op call option offering may pay earnest money to participate. Earnest money may go toward the purchase of the shares of the co-op option offering. The exchange may refund earnest money whenever a co-op fails to find sufficient participants to purchase the underlying option contract for the co-op option offering by its closing date. If a participant in a co-op option offering fails to pay for their pledged shares, they may forfeit their earnest money. Earnest money collected from a participant that fails to pay may be shared proportionately with the remaining participants in the co-op call option offering.

In accordance with certain aspects described herein, the exercise and fulfillment of a retail call option or a co-op retail call option share is accomplished by a system that contains a processor, memory files containing information that identifies option holders and memory files containing information about each option holder's retail call options and/or co-op retail call option shares. This system for exercising and fulfilling retail call options and/or co-op retail call option shares also contains memory files comprising code executable by the processor for processing retail call options. The processor using this executable code identifies the option holder, accesses the option holder's retail call options and/or co-op retail call option shares, checks for a match between the assets in option holder's retail call options and/or co-op retail call option shares and the items being purchased. If a match is found, and the option holder has elected for automatic exercise and fulfillment of their retail call options and/or co-op retail call option shares, the retail call options and/or co-op retail call option shares may be automatically exercised and fulfilled, in response to the prices of the applicable products, commodities, and/or services is higher than the specified prices in the retail call options and/or co-op retail call option shares.

In accordance with certain aspects described herein, option holders may choose to go through a verification process before exercising and/or fulfilling a retail call option or a co-op retail call option share. If an option holder elects verification before exercising a retail call option or a co-op retail call option share, the executable code used by the system that exercises and fulfils retail call options and call option shares may display a message stating that a retail call option or a co-op retail call option share was found on the system that will lower the cost of a named item. In this summary may be the current price of the stated item, the adjusted price if the retail call option or co-op retail call option share is exercised and fulfilled and/or the possible cost savings from exercising and fulfilling the retail call option or co-op retail call option share. Action buttons labeled “Exercise Option” and “Don't Exercise Option” may be available for indicating if a system should proceed with exercising the retail call option or co-op retail call option share.

In accordance with various embodiments, the option holder's identifying information may be entered into a system for exercising and fulfilling a retail a call options and/or co-op retail call option shares that may be a point-of-sale system, an e-commerce site and/or seller's ordering software using various methods that may include but are not limited to: the manual entering of an alphanumeric code, reading the information on a magnetic stripe card, reading an optical machine-readable representation of data displayed on a card or digital device, obtaining information gained from biometric screening, manual entering of a user's username and password; obtaining identifying information sent by a smartphone app, manual entering of a customer's name, manual entering of a company's name and/or manual entering of a customer identification number.

In accordance with certain aspects described herein, an application that may be called “ROE Contracts,” (e.g., app) may be used to view active retail call options and/or co-op retail call option shares on an electronic device (e.g., a portable electronic device, a smartphone, a tablet, a computer, etc.). The user may press a listed retail call option or retail call option share to get one or more of the following information: a description of the retail product and/or service which the retail option or the co-op retail call option share covers, the name of a wholesaler and/or retailer that wrote the retail option, the name of the seller that sold the call option or co-op retail call option share, the maximum price per unit of a product, commodity and/or service, the start date, the expiry date, the remaining number of units that a customer can purchase with the retail call option or retail call option share, a notification regarding permission or denial of resale of the retail call option an exchange and the minimum number of units per sale, if applicable. A link or button labeled “Order Online” may also be be provided to navigate to the option writer's e-commerce website.

In accordance with certain aspects described herein, a point-of-sale system may look up any applicable retail option contracts and/or co-op retail call option shares that may apply to items entered into a system, after identifying an option holder. If the option holder has elected for automatic exercise and/or fulfillment of their retail call options and/or co-op retail call option shares, the point-of-sale system may automatically adjust prices of applicable products, commodities, and/or services entered into the point-of-sale system in response to the prices of the applicable products, commodities, and/or services being higher than the specified prices in the retail call options and/or co-op retail call option shares.

In accordance with certain aspects described herein, option holders may choose to have point-of-sale systems go through a verification process before exercising and/or fulfilling each of their retail call options and/or co-op retail call option shares. If an option holder elects verification before exercising a retail call option and/or a co-op retail call option share, a separate message may appear in a pop-up box for every item listed on the point-of-sale system that has a matching asset in a retail call option and/or retail call option share. Each message would state that a retail call option or a co-op retail call option share was found on the system that will lower the cost of a named item. In this summary may be the current price of the stated item, the adjusted price if the retail call option or co-op retail call option share is exercised and fulfilled and/or the possible cost savings from exercising and fulfilling the retail call option or the co-op retail call option share. Action buttons labeled “Exercise Option” and “Don't Exercise Option” may be available for indicating if a system should proceed with exercising the retail call option or co-op a retail call option share.

In accordance with certain aspects described herein, holders of retail call options and/or co-op retail call option shares can exercise their call options and/or their co-op retail call option shares and have them fulfilled by e-commerce websites.

In accordance with certain aspects described herein, information may entered into an e-commerce site to identify an option holder. In response to an option holder using the ROE Contracts app to navigate to an option writer's e-commerce website, the ROE Contracts app may send information that identifies the option holder.

In accordance with certain aspects described herein, an e-commerce website may look up any applicable retail option contracts and/or co-op retail call option shares that apply to items entered in a shopping cart, after identifying an option holder. If the option holder has elected for automatic exercise and/or fulfillment of their retail call options and/or their co-op retail call option shares, an e-commerce site may automatically adjust prices of applicable products, commodities, and/or services in a shopping cart, in response to the prices of the applicable products, commodities, and/or services is higher than the specified prices in the retail call options and/or co-op retail call option shares.

In accordance with certain aspects described herein, option holders can choose to have e-commerce sites go through a verification process before exercising and/or fulfilling their retail call options and/or co-op retail call option shares. If an option holder elects verification before exercising a retail call option and/or a co-op retail call option share, a separate message may appear in a pop-up box for every item listed on the checkout page that has a matching asset in a retail call option and/or retail call option share. Each message would state that a retail call option or a co-op retail call option share was found on the system that will lower the cost of a named item. In this summary may be the current price of the stated item, the adjusted price if the retail call option or co-op retail call option share is exercised and fulfilled. and/or the possible cost savings from exercising and fulfilling the retail call option or the co-op retail call option share. Action buttons labeled “Exercise Option” and “Don't Exercise Option” may be available for indicating if a system should proceed with exercising the retail call option or co-op a retail call option share.

In accordance with certain aspects described herein, holders of retail call options can exercise their retail call options and or retail call option shares and/or have them fulfilled by a seller's order entry software.

In accordance with certain aspects described herein, a seller taking an order may enter information that identifies an option holder before proceeding with processing an order on the seller's system.

In accordance with certain aspects described herein, a seller's ordering software may look up any applicable retail call options and/or retail call option shares that apply to items entered on an ordering page, after identifying an option holder. If the option holder has elected for automatic exercise and/or fulfillment of their retail call options and/or retail call option shares, a seller's selling software may automatically adjust prices of applicable products, commodities, and/or services that are listed on an ordering page, in response to the prices of the applicable products, commodities, and/or services being higher than the specified prices in the retail call options and/or co-op retail call option shares.

In accordance with certain aspects described herein, option holders can choose to have seller's selling software go through a verification process before exercising and/or fulfilling their retail call options or retail call option shares. If an option holder elects verification before exercising a retail call option and/or a co-op retail call option share, a separate message may appear in a pop-up box for every item listed on the checkout page that has a matching asset in a retail call option and/or retail call option share. Each message would state that a retail call option or a co-op retail call option share was found on the system that will lower the cost of a named item. In this summary may be the current price of the stated item, the adjusted price if the retail call option or co-op retail call option share is exercised and fulfilled. and/or the possible cost savings from exercising and fulfilling the retail call option or the co-op retail call option share. Action buttons labeled “Exercise Option” and “Don't Exercise Option” may be available for the seller to proceed with exercising a retail call option and/or a call option share after verifying with the option holder.

In accordance with various embodiments, a summary of total and individual cost savings from exercising and/or fulfilling any retail call option contracts may be displayed on store receipts, e-mail receipts, e-commerce checkout pages, and/or inserts placed in shipping containers.

In accordance with some embodiments, whenever a retail call option and/or a co-op retail call option share is exercised and/or fulfilled, the number of remaining units that a customer can purchase with the contract are lowered by the units purchased, if applicable. The buyer's ledger, the seller's ledger, and/or the exchange's digital distributed ledger are updated in response to there being adjustments to the remaining units that a customer can purchase with their call option and/or a co-op retail call option share.

In accordance with various embodiments described herein, the Retail Options Exchange may use distributed digital ledger technology to inhibit hacking, alteration, and/or loss of option contract and/or financial information used by the Retail Options Exchange. In this ledger, there may be a record of all the retail option contracts written, bid and asked. A recording in this ledger is also made whenever a retail call option and/or a co-op retail call option share is sold, resold, exercised, and/or fulfilled. This ledger system may track and/or record adjustments made to remaining units that a customer can purchase by exercising a particular retail call option or co-op retail call option share. The Retail Options Exchange may continuously update the individual ledgers regarding retail call options and/or retail call option shares for participants on the Retail Options Exchange. These updates may also be shared with systems that are used by option holders to exercise their retail call options and/or co-op retail call option shares and/or have them fulfilled.

In accordance with one embodiment, an exchange (e.g., “Government Options Exchange”) may be used for writing, bidding, and/or selling four unique types of call options called government-sponsored call option contracts. One type of government-sponsored call option may be used to specify a property tax rate for a specified amount of time. Another type of government-sponsored call option may specify an income tax rate during a stated start date and expiry date. The third type of government-sponsored call option may grant the holder a specified sales tax and/or value-added tax on a set maximum total value of the product, commodity, and/or service for a specified period. The fourth type of government-sponsored call option may grant the holder a specified customs duty tax and/or excise duty tax on particular goods for a stipulated maximum total number of goods for a specified time.

Accordance with certain aspects described herein, government-sponsored call option contracts may be written and/or sold on a membership website that may be called the “Government Options Exchange.” The Government Options Exchange website may have two or more portals. One of these portals may be restricted to government agencies that write government-sponsored call options. Another portal on the Government Options Exchange website may be for companies and/or persons that want to buy government-sponsored call options.

In certain embodiments, a restricted portal for government option writers may provide pages to accomplish various tasks. One page may be provided for reviewing existing option contracts. This page may also be used to write new government-sponsored call option bids and/or to submit them to the Government Options Exchange. This page may also offer ways for option writers to initiate contact with their option holders.

Another page that may be provided to writers of government-sponsored call options to manage their membership. On this page, option writers may indicate their notification preferences (e.g., text and/or e-mail). Option writers may also set up a method for electronically paying their fees and/or how they want to receive payment for selling government-sponsored call options. A separate page may also be available to option writers for managing an exchange license. On this page, option writers may list types of taxes they intend to write options for.

Option writers may also have full access to the Government Options Exchange. One reason why option writers may view option bids on the Government Options Exchange is to check out option bids offered by other cities, counties, and/or states.

Accordance with certain aspects described herein, another portal on the Government Options Exchange website may be for companies and/or persons that want to buy government-sponsored call options. A person and/or company may become a member to get access to the Government Options Exchange. The exchange may give a free trial membership to new users. At the option of the Government Options Exchange, customer memberships may remain free or may be extended for a nominal fee after their free trial period has expired.

Accordance with certain aspects described herein, companies and/or persons that want to buy government-sponsored call options may have to provide information in order to obtain membership on the Government Options Exchange such as: name, address, e-mail address, phone number, financial payment method (e.g., credit card, PayPal®, debit card, etc.) for paying fees and/or for purchasing options, method for receiving payment for selling existing options, how they want notifications to be sent (e.g., text and/or e-mail), and/or an indication about whether the user wants to automatic exercise and/or fulfill their government-sponsored call options that specify a sales and/or value-added tax rate, in response to the current sales and/or value-added tax rate being higher than a specified tax rate in the user's call option contracts. If an option holder chooses not to automatically exercise and/or fulfill their government-sponsored call option contracts that specify a sales and/or value-added tax rate, the option holder may go through a verification process at a time before the option holder exercises their call options.

In accordance with certain aspects described herein, a portal for taxpayers may provide pages for searching, selecting, and/or purchasing government-sponsored call options on the Government Option Exchange. Separate pages may be used to search for government-sponsored call option contracts regarding property taxes, income taxes, sales taxes, and/or value-added taxes, and/or options regarding excise duties and/or customs duties.

Accordance with certain aspects described herein, agreements outlined in government-sponsored call options regarding property taxes and/or income taxes can be viewed by the buyer and/or the government agency that wrote the contract on web pages provided by the Government Options Exchange.

Accordance with certain aspects described herein, government-sponsored call options, along with option holder's identity information may be transmitted to a respective government agency's computer system that calculates and/or charges the tax that is specified by the call option.

Accordance with certain aspects described herein, the conditions spelled out in the government call option contract that specify a property tax rate, an income tax rate, a customs duty tax rate, and/or an excise tax rate may be automatically applied to the option holder's taxes in response to the current tax rate being higher than the tax rate specified in the government-sponsored call option.

In accordance with certain embodiments, holders of government-sponsored call option contracts that specify a sales and/or value-added tax can exercise these options and/or get them fulfilled at point-of-sales systems in stores and/or in service outlets, on e-commerce sites, and/or by a seller's ordering software.

Accordance with certain aspects described herein, government-sponsored call options that set a sales and/or value-added tax may have a disclaimer that notifies potential buyers that not all stores and/or e-commerce sites process these option contracts. The Government Option Exchange may urge potential buyers of this type of option to verify that the stores and/or e-commerce sites they plan to use can process government-sponsored call option contracts. On a page for searching and/or for buying these types of options there may be a search box for entering in store names and/or names of e-commerce sites to check that they exercise and/or fulfill these types of options.

In accordance with certain aspects described herein, the exercise and fulfillment of government-sponsored call options are accomplished by a system that contains a processor, memory files containing information that identifies option holders, memory files containing information about each option holder's government-sponsored call options. This system for exercising and fulfilling government-sponsored call options also contains memory files comprising code executable by the processor for processing government-sponsored call options. The processor using this executable code identifies the option holder, accesses the option holder's government-sponsored call options and checks for a match between the underlying asset that is a specified tax rate represented by the holder's government-sponsored call option, and a tax rate being charged. If a match is found, and the option holder has elected for automatic exercise and fulfillment of their government-sponsored call options, the options may be automatically exercised and fulfilled, in response to the specified tax rate in the call option being less than the existing tax rate.

In accordance with certain aspects described herein, option holders may choose to go through a verification process before exercising and/or fulfilling their government-sponsored call options. If an option holder elects verification before exercising a government-sponsored call option, the executable code used by the system that exercises and fulfills government-sponsored call options may display a message stating that a government-sponsored call option call option was found on the system that will lower a named tax. In this summary may be the current tax rate, the adjusted tax rate if the government-sponsored call option is exercised and fulfilled. and/or the possible cost savings from exercising and fulfilling the government-sponsored call option. Action buttons labeled “Exercise Option” and “Don't Exercise Option” may be available for indicating if a system should proceed with exercising the government-sponsored call option.

In accordance with various embodiments, the option holder's identifying information may be entered into a system for exercising and fulfilling government-sponsored call options that may be a point-of-sale system, an e-commerce site and/or seller's ordering software using various methods that may include but are not limited to: the manual entering of an alphanumeric code, reading the information on a magnetic stripe card, reading an optical machine-readable representation of data displayed on a card or digital device, obtaining information gained from biometric screening, manual entering of a user's username and password; obtaining identifying information sent by a smartphone app, manual entering of a customer's name, manual entering of a company's name and/or manual entering of a customer identification number.

In accordance with certain embodiments, an app, that may be called “GOV Options,” may be used to verify if a store and/or if an e-commerce site processes government-sponsored call options that specify a sales and/or value-added tax rate. This app may have a search box for entering the name of a store or e-commerce website. Below this search box, there may be two action buttons. A top button may be labeled “Verify” and may be used to check if a store and/or e-commerce website processes government-sponsored call options that set a sales tax and/or value-added tax. A lower button may be labeled “Order Online” and may be used to navigate to an e-commerce website listed in the search box.

In accordance with certain embodiments, the GOV Options app may display a user's active government-sponsored call options. The option holder can press a listed GOV option contract to get one or more of the following information: a short description of the government-sponsored call option, a specified sales tax and/or value-added tax, the remaining amount of money that can be spent on products and/or services that get charged a specified sales and/or value-added tax by exercising and fulfilling the government-sponsored call option, the name of a government agency that wrote the option contract, the start date and the expiry date.

In accordance with some embodiments, holders of government-sponsored call options that set a maximum sales tax and/or value-added tax may use a unique OR code and/or barcode displayed on an application called “GOV Options” for identification of the option holder at point-of-sale systems.

In accordance with various embodiments, a point-of-sale system may look up any applicable government-sponsored call option that specifies a sales and/or value-added tax rate that would apply to items purchased, after identifying the option holder. If the option holder has elected for automatic exercise and/or fulfillment of their government-sponsored call option, the point-of-sale system may adjust the sales and/or value-added tax, in response to the specified sales and/or value-added tax rate in the call option being less than the existing sales and/or value-added tax rate.

In accordance with certain embodiments, option holders can choose to have point-of-sale systems go through a verification process before exercising and/or fulfilling their government-sponsored call options that specify a sales and/or value-added tax rate. If an option holder elects verification before exercising a government-sponsored call option, a message may appear on the point-of-sale screen before the sale is finalized. In this message may be a summary of a current tax rate, a tax rate specified in the call option, and/or cost savings from exercising the call option. Action buttons labeled “Exercise Option” and “Don't Exercise Option” may be available for indicating if a system should proceed with exercising and/or fulfilling the government-sponsored call option.

In accordance with some embodiments, government-sponsored call option contracts that specify a sales and/or value-added tax can be exercised and/or fulfilled on e-commerce sites.

In accordance with various embodiments, information that identifies an option holder may be entered into the e-commerce website. One method of entering identifying information is with an app. This app can also be used to navigate to an e-commerce website.

In accordance with certain embodiments, an e-commerce site looks up an applicable government-sponsored call option that specifies a sales and/or value-added tax rate that may apply to items purchased after identifying the option holder. If the option holder has elected for automatic exercise and/or fulfillment of their government-sponsored call option, the e-commerce site may adjust the sales tax and/or the value-added tax, in response to the specified sales and/or value-added tax rate in the call option being less than the existing sales and/or value-added tax rate.

In accordance with some embodiments, option holders can choose to have e-commerce sites go through a verification process before exercising and/or fulfilling their government-sponsored call options that specify a sales and/or value-added tax rate. If an option holder elects verification before exercising a government-sponsored call option, a pop-up box may appear on the checkout page before the sale is finalized. In this box may be a summary of a current tax rate, a tax rate specified in the call option, and/or cost savings from exercising the call option. Action buttons labeled “Exercise Option” and “Don't Exercise Option” may be available for indicating if a system should proceed with exercising the government-sponsored call option.

In accordance with various embodiments, holders of government-sponsored call options that specify a sales and/or value-added tax rate can exercise their call options and/or have them fulfilled by seller's order entry software.

In accordance with certain embodiments, a seller taking an order may enter information that identifies an option holder before proceeding with processing the order on the seller's system.

In accordance with some embodiments, a seller's ordering software may look up any government-sponsored call options owned by an option holder that is in a system, after an option holder is identified. If the option holder has elected for automatic exercise and/or fulfillment of their government-sponsored call option, the seller's ordering software may adjust the sales and/or value-added tax, in response to the specified sales and/or value-added tax rate in the call option being less than the existing sales and/or value-added tax rate.

In accordance with certain embodiments, option holders can elect to have seller's ordering software go through a verification procedure before exercising and/or fulfilling their government-sponsored call options that specify a sales and/or value-added tax rate. If an option holder elects verification before exercising a government-sponsored call option, a pop-up box may appear on the checkout page before the sale is finalized. In this box may be a summary of a current tax rate, a tax rate specified in the call option, and/or cost savings from exercising the call option. Action buttons labeled “Exercise Option” and “Don't Exercise Option” may be available for indicating if a system should proceed with exercising the government-sponsored call option.

In accordance with various embodiments, whenever a government-sponsored call option contract that sets a sales and/or value-added tax rate is exercised and/or fulfilled, software used to exercise and/or fulfill the call option may adjust a remaining amount of money that can be spent on purchases using the option contract. The buyer's ledger, the seller's ledger, the government agency's ledger, and/or the exchange's digital distributed ledger may be updated whenever there are adjustments to a remaining monetary value of purchases that can receive the specified sales and/or value-added tax using the government-sponsored call option contract.

If a government-sponsored call option contract is exercised to get a specified excise duty and/or customs duty, adjustments may be made to the remaining number of goods that can get this specified tax rate. The buyer's ledger, the government agency's ledger, and/or the exchange's digital distributed ledger may be updated with regards to these adjustments.

In accordance with certain embodiments, a summary of a total and/or individual cost savings from exercising and/or fulfilling any government-sponsored call option that sets a sales tax and/or value-added tax may be displayed on store receipts, e-mail receipts, e-commerce checkout pages, and/or inserts placed in shipping containers.

The Government Options Exchange may update (e.g., continuously, after each transaction, etc.) individual ledgers regarding their government-sponsored call option contracts for every participant on the exchange. These updates may be shared with systems that exercise and/or fulfill government-sponsored call option contracts.

In accordance with some embodiments, the Government Options Exchange uses distributed ledger technology to inhibit hacking, alteration, loss of option contract information, and/or financial data used by the exchange. In this ledger may be a record of government-sponsored call option contracts written, bid, sold, resold, exercised, and/or fulfilled.

### BRIEF DESCRIPTION OF THE DRAWINGS

The preceding and other aspects of these teachings are made more evident in the following Detailed Description, when read in conjunction with the attached drawings, wherein:

FIG. 1 illustrates one embodiment of a computer page on a trading platform for selecting call options;

FIG. 2 illustrates one embodiment of how a user can eliminate options from a display of call options on a trading platform in order to simplify data analysis;

FIG. 3 shows one embodiment of a computer page used by option writers to create call option bids to be posted on an options exchange;

FIG. 4 shows one embodiment of navigation to a computer page for option writers used to review call options they have written and/or to write new option bids;

FIG. 5 illustrates one embodiment of a computer page used by option writers to review call options they have written and to write new option bids;

FIG. 6 shows one embodiment of a pop-up box displaying a list of option holders of a particular call option that was written by an option writer;

FIG. 7 illustrates one embodiment of a pop-up box for obtaining contact information whenever an option writer selects an option holder from the list of option holders in the pop-up box described in FIG. 6;

FIG. 8 demonstrates one embodiment of navigation to a computer page for option writers used to review requests for call options;

FIG. 9 illustrates one embodiment of a computer page used by option writers to review requests for option bids and/or to write new option bids;

FIG. 10 demonstrates one embodiment of navigation to computer pages used by option holders;

FIG. 11 shows one embodiment of navigation to a computer page used by an option holder to review their call options, place their call options on the exchange for sale and/or request a call option from option writers on an exchange;

FIG. 12 shows one embodiment of a page used by option holders to review their options, to contact option writers regarding options they own, to place their call options on the exchange for sale and/or to request a call option from option writers on an exchange;

FIG. 13 shows one embodiment of a pop-up box that displays contact information for a particular option writer whenever a user makes a selection from their list of existing options as described in FIG. 12;

FIG. 14 demonstrates one embodiment of how an option holder initiates the sale of an existing option if permitted by an option writer;

FIG. 15 shows one embodiment of a page used by an option holder to prepare and/or put an option up for sale on an exchange if permitted by an option writer;

FIG. 16 demonstrates one embodiment of navigation to a computer page used by an option holder to review their call options being sold on an exchange;

FIG. 17 illustrates one embodiment of how an option holder views and/or removes options the option holder has for sale on a Retail Options Exchange;

FIG. 18 shows one embodiment of a computer page on a trading platform for selecting co-op options offers;

FIG. 19 illustrates one embodiment of how to eliminate co-op option offers from a display of co-op option offerings on a trading platform, select co-op option offers to participate, and/or initiate the creation of a new co-op option offer;

FIG. 20 describes one embodiment of a computer page for selecting an existing option for creating a new co-op option offering;

FIG. 21 illustrates one embodiment of how a user can eliminate options from a table of options described in FIG. 20 in order simplify the data analysis by removing unwanted options;

FIG. 22 describes one embodiment of a computer page for creating a new co-op option offering;

FIG. 23 illustrates one embodiment of an options exchange app on a cell phone for exercising and/or fulfilling call option contracts at point-of-sale systems;

FIG. 24 demonstrates one embodiment of how an app is used to exercise and fulfill a call option contract on an option writer's e-commerce website;

FIG. 25 shows one embodiment of a home page for a membership website used for writing and/or selling government-sponsored call option contracts;

FIG. 26 shows one embodiment of a pop-up box for initiating a search for government-sponsored options that specify a property tax rate for a specified amount of time;

FIG. 27 shows one embodiment of the page for displaying and/or purchasing government-sponsored options that specify a property tax rate;

FIG. 28 shows one embodiment of an example of a pop-up box that displays a message that a user may receive an option bid price in an email;

FIG. 29 shows one embodiment of a pop-up box for initiating a search for government-sponsored options that specify an income tax rate for a specified amount of time;

FIG. 30 shows one embodiment of a computer page that displays government-sponsored options that specify an income tax rate;

FIG. 31 shows one embodiment of a pop-up box for initiating a search for government-sponsored options that grant a holder a specified sales and/or value-added tax on a specified maximum total value of the product, commodity, and/or service for a specified amount of time;

FIG. 32 shows one embodiment of a web page for displaying and/or purchasing government-sponsored options that set a sales and/or value-added-tax rate;

FIG. 33 shows one embodiment of a pop-up box containing a disclaimer that states that not all stores and/or e-commerce sites process government-sponsored call options that specify a sales or value-added tax;

FIG. 34 shows one embodiment of an example of verification that a particular store and their e-commerce site processes a government-sponsored option that specifies a sales tax rate;

FIG. 35 shows one embodiment of a pop-up box for initiating a search for government-sponsored options that grant a holder a specified excise duty tax and/or customs duties tax for a specified amount of product for a specified period;

FIG. 36 shows one embodiment of a web page for displaying available option contracts that set an excise duty and/or customs duty after a user initiates a search as illustrated in FIG. 28;

FIG. 37 demonstrates one embodiment of how an option writer accesses pages for writing and/or managing government option bids;

FIG. 38 shows one embodiment of the computer page used by option writers to create government-sponsored option bids and/or options;

FIG. 39 shows one embodiment of the page an option writer uses for reviewing government-sponsored options contracts they have written;

FIG. 40 describes one embodiment of a pop-up box containing information about the option holders who purchased a particular option that is displayed in response to an option writer initiating a query as described in FIG. 39;

FIG. 41 describes one embodiment of how an app may be used to verify whether stores and/or e-commerce sites process government-sponsored options that specify a sales and/or value-added tax;

FIG. 42 describes one embodiment of how an app may be used to exercise and/or fulfill government-sponsored options that specify a sales and/or value-added tax on point-of-sales systems;

FIG. 43 shows one embodiment that may be used for verification by the option holder before a system exercises and fulfills a retail call option; and

FIG. 44 shows one embodiment that may be used for verification by the option holder before a system exercises and fulfills a government-sponsored call option that specifies a sales tax.

### DETAILED DESCRIPTION

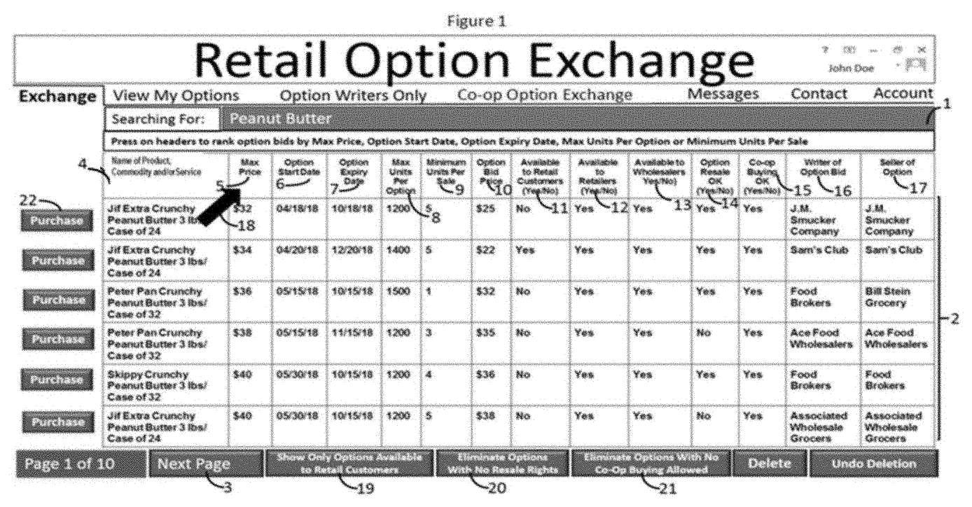

FIG. 1 illustrates a computer page on a trading platform for selecting call options. On the top of this page is a search box 1 for finding a product, commodity or service. A list of option bids most closely associated with the word or words submitted in the search box is displayed in a table format 2 after a user initiates a search. A “Next Page” button 3 can be used to view more search results than what is displayed. The following are the headings for each column listed from left to right in the table 2: The Name of Product, Commodity and/or Service 4, Max Price 5, Option Start Date 6, Option Expiry Date 7, Max Units Per Option 8, Minimum Units Per Sale 9, Option Bid Price 10, Available to Retail Customers (Yes/No) 11, Available to Retailers (Yes/No) 12, Available to Wholesalers (Yes/No) 13, Option Resale OK (Yes/No) 14, Co-op Buying OK (Yes/No) 15, Writer of Option Bid 16 and the Seller of Option 17.

FIG. 1 also illustrates the software tools that allow users to quickly rearrange a list of options so that they can analyze and chose an option that will most closely meet their needs. In this illustration, an arrow 18 is pointing to the header in the column labeled Max Price 5. Clicking on this header 5 causes the call options listed in the table 2 to be ranked from lowest to highest with regards to maximum price. When the user clicks on the header labeled Option Start Date 6, the call options listed in the table 2 are ranked from soonest to latest according to their start date. Options in the table 2 can be ranked from latest to soonest regarding expiry date, by clicking on the header labeled Option Expiry Date 7. The user can rank options from most to least number of maximum units the option writer will fulfill with the option by clicking on the header labeled Max Units per Option 8. To rank the call options from least to the most number of minimal units required per sale when exercising a retail call option is accomplished by clicking on the header labeled Minimum Units Per Sale” 9. If a user clicks on the action button labeled “Show Only Options Available to Retail Customers” 19, the software displays only call options that allow purchase and use by retail customers. Clicking on the action button labeled “Eliminate Options with No Resale Rights” 20 eliminates all the call options that don't allow resale. An action button labeled “Eliminate Options with No Co-op Buying Allowed” 21 removes option bids that don't allow co-op buying. When a user clicks on the action button labeled “Purchase” 22, positioned to the left of an option choice, it starts the purchase process and navigates to a checkout page for confirmation.

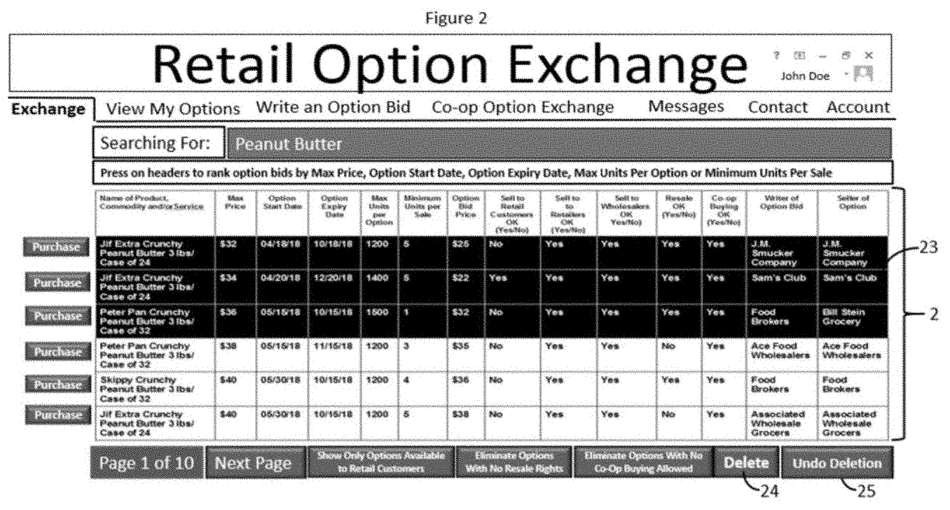

FIG. 2 illustrates a user highlighting options 23, by pressing the left mouse button on a conventional computer screen or pressing with a finger on a touchscreen while swiping from top to bottom and left to right in the table listing call options 2. A user can delete highlighted material by pressing the “Delete” action button 24. An action button labeled “Undo Deletion” 25 is available to undo deletions.

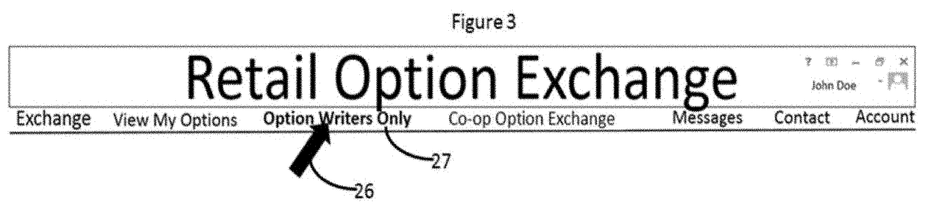

FIG. 3 illustrates an arrow 26 pointing to the upper menu item labeled Option Writers Only 27. Clicking on this upper menu item 27 causes the computer program to display submenu for either accessing the page that lists the option writer's existing option bids or the page that lists requested bids. Each of these pages also contains tools to create an option.

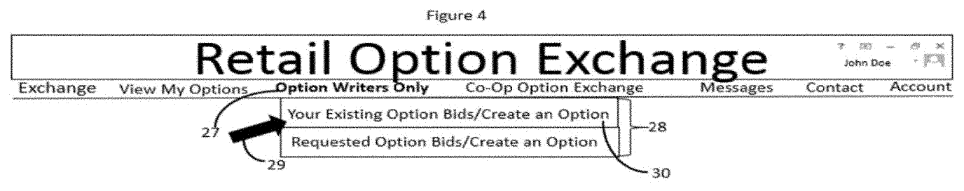

FIG. 4 illustrates the submenu 28 that is displayed by clicking on the upper menu item labeled Option Writers Only 27 as described in FIG. 3. In this illustration, an arrow 29 is pointing to the upper submenu item labeled “Your Existing Option Bids/Create an Option” 30. Clicking on this upper submenu item 30 causes the computer program to navigate to a page that displays the option writer's existing option bids. This page also contains tools for creating an option.

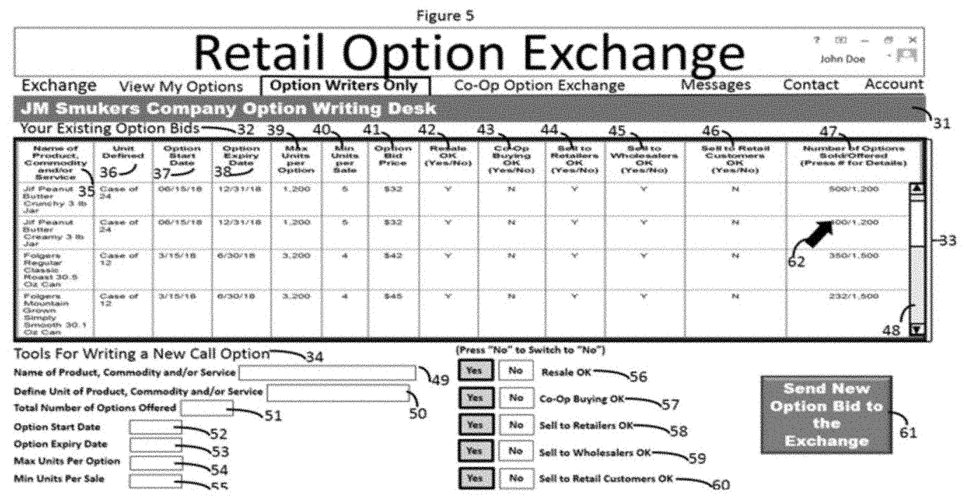

FIG. 5 shows a computer page that displays the option writer's option writing desk 31 containing a list of the option writer's existing option bids 32 that are posted on the exchange displayed in a table format 33. This page also contains tools for creating a new call option 34. The following are the headings for each column listed from left to right in the table 32: Name of Product, Commodity and/or Service 35. Unit Defined 36, Option Start Date 37, Option Expiry Date 38, Max Units Per Option 39, Min Units Per Sale 40, Option Bid Price 41, Resale OK (Yes/No) 42, Co-op Buying OK (Yes/No) 43, Sell to Retailers OK (Yes/No) 44, Sell to Wholesalers OK (Yes/No) 45, Sell to Retail Customers OK (Yes/No) 46 and Number of Options Sold/Offered (Press # for Details) 47. On the right side of the table, 33 is a scroll bar 48 to allow viewing of other existing options that are not currently displayed.

FIG. 5 also shows a section at the bottom of the page used by option writers to write a new call option 34. In this section, a user types in the name of a product, commodity, and/or service in a data entry box labeled “Name of Product, Commodity and/or Service” 49. The option writer types in a description of the unit of product, commodity, and/or service in the data entry box labeled “Define Unit of Product, Commodity and/or Service” 50. Other data entries include the Total Number of Options Offered 51, Option Start Date 52, an Option Expiry Date 53, Max Units per Option 54, and Min Units per Sale 55, A column of Yes/No toggle switches, with the switch set on “Yes” by default may be used by option writers to indicate if Resale OK (Yes/No) 56, if Co-op Buying OK (Yes/No) 57, if Sell to Retailers OK (Yes/No) 58, if Sell to Wholesalers OK (Yes/No) 59, and/or if Sell to Retail Customers OK (Yes/No) 60. After the option writer completes the data entry for a call option, the option writer can post it on the exchange by pressing the action button labeled “Send New Option Bid to the Exchange” 61.

In FIG. 5, an arrow 62 is pointing to the number of options sold and offered that is listed in the column labeled Number of Options Sold/Offered (Press # for Details) 47 for a call option in the displayed table of the option writer's existing option bids 32. In response to a user using a mouse or a finger to point and select a number in this column, it brings up a pop-up box that displays a list of all of the holders of that call option described in that row.

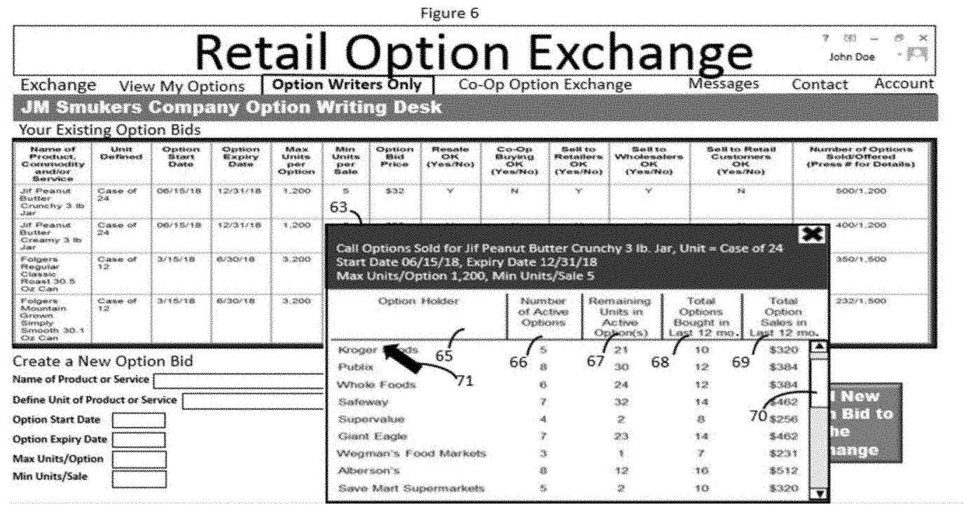

FIG. 6 illustrates one embodiment of a pop-up box 63 displaying a list of option holders of a particular call option that was acquired and displayed using the process described in FIG. 5. At the top of the pop-up box 63, is a summary of existing call option 64. Below this summary is a table with five columns with the following headers listed from left to right: Option Holder 65, Number of Active Options 66, Remaining Units in Active Options 67, Total Options Bought in Last 12 Mo. 68, and Total Option Sales in Last 12 mo. 69. A scroll bar 70 may be provided on the side of the pop-up box 63 for viewing additional option holders.

In FIG. 6, an arrow 71 is pointing to a holder of a call option listed in the pop-up box 63. When a user selects an option holder in this first column, it brings up another pop-up box that contains various ways to contact that option holder

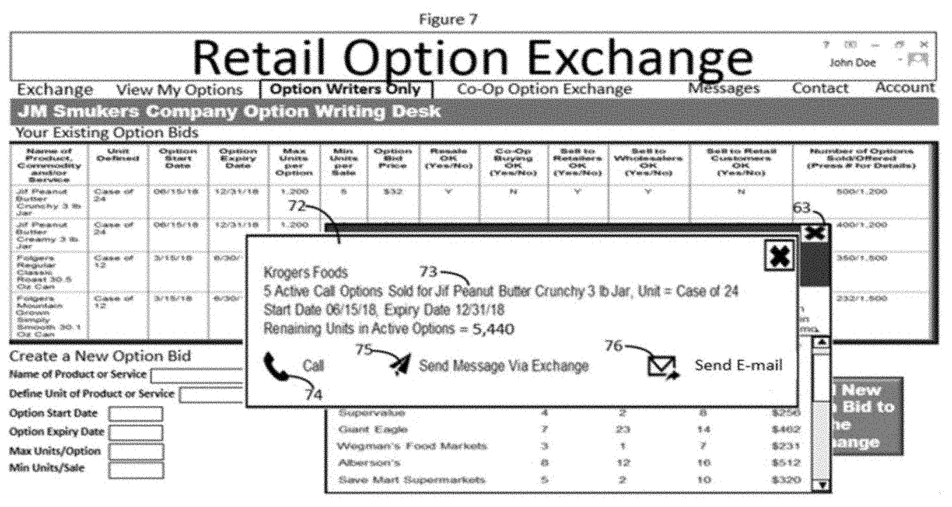

FIG. 7 shows one embodiment of a second pop-up box 72 for obtaining contact information whenever a user selects an option holder from the list in the pop-up box 63, as described in FIG. 4. A summary 73 of how many options the selected option holder has, how many remaining units of product and/or service they can buy with their options, and/or their year over year buying activity for the option that was selected is listed at the top of the pop-up box 72. The user can point and select a phone icon 74 to obtain a phone number and call the option holder. Alternatively, the user can press a paper airplane icon 75 to send an internal message via the Exchange. The option writer can also press an e-mail icon 76 to initiate creation and/or sending an e-mail message.

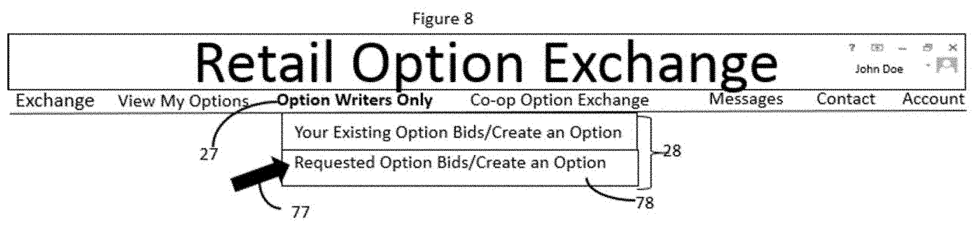

FIG. 8 illustrates the submenu 28 that is displayed by clicking on the upper menu item labeled Option Writers Only 27 as described in FIG. 3. In this illustration, an arrow 77 is pointing to the lower submenu item labeled “Requested Option Bids/Create an Option” 78. Clicking on this lower submenu item 78 causes the computer program to navigate to a page that displays requested option for products, commodities and/or services that the option writer writes options for. This page also contains tools for creating an option.

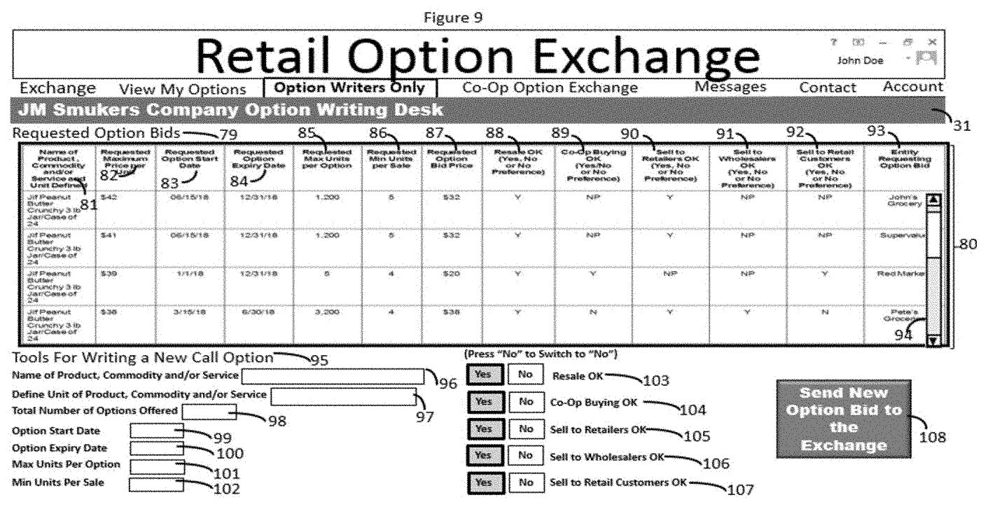

FIG. 9 shows a computer page that displays the option writer's desk 31 containing a list of requested option bids 79 that are posted on the exchange displayed in a table format 80 for products, commodities, and/or services that the option writer provides. The following are the headings for each column listed from left to right in the table 80: Name of Product, Commodity and/or Service and Unit Defined 81, Requested Maximum Price 82, Requested Option Start Date 83, Requested Option Expiry Date 84, Requested Max Units per Option 85, Requested Min Units per Sale 86, Requested Option Bid Price 87, Resale OK (Yes, No or No Preference) 88, Co-Op Buying OK (Yes, No or No Preference) 89, Sell to Retailers OK (Yes, No or No Preference) 90, Sell to Wholesalers OK (Yes, No or No Preference) 91, Sell to Retail Customers OK (Yes, No or No Preference) 92, Entity Requesting Option Bid 93. On the right side of the table 80, is a scroll bar 94 that enables viewing of other requests for option bids that are not currently displayed.

FIG. 9 also shows a section at the bottom of the page used by option writers to write a new call option 95. In this section, a user types in the name of a product, commodity, and/or service in a data entry box labeled “Name of Product, Commodity and/or Service” 96. The option writer types in a description of the unit of product, commodity, and/or service in the data entry box labeled “Define Unit of Product, Commodity and/or Service” 97. Other data entries include the Total Number of Options Offered 98, Option Start Date 99, an Option Expiry Date 100, Max Units per Option 101, and Min Units per Sale 102, A column of Yes/No toggle switches, with the switch set on “Yes” by default may be used by option writers to indicate if Resale OK (Yes/No) 103, if Co-op Buying OK (Yes/No) 104, if Sell to Retailers OK (Yes/No) 105, if Sell to Wholesalers OK (Yes/No) 106, and/or if Sell to Retail Customers OK (Yes/No) 107. After the option writer completes the data entry for a call option, the option writer can post it on the exchange by pressing the action button labeled “Send New Option Bid to the Exchange” 108.

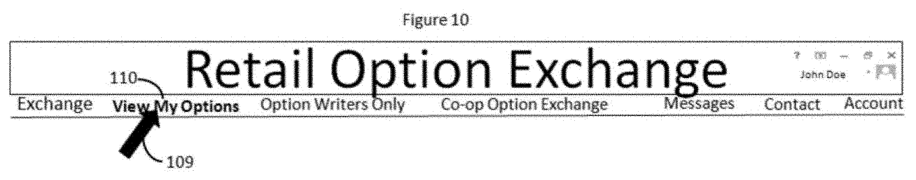

FIG. 10 illustrates an arrow 109 pointing to the upper menu item labeled “View My Options” 110. Clicking on this upper menu item 110 causes the computer program to display submenu for either accessing the page that lists the option holder's existing options, tools for placing an option up for sale on the exchange and tools for requesting an option bid from option writers. The other submenu navigates to the page that lists the user's options for sale.

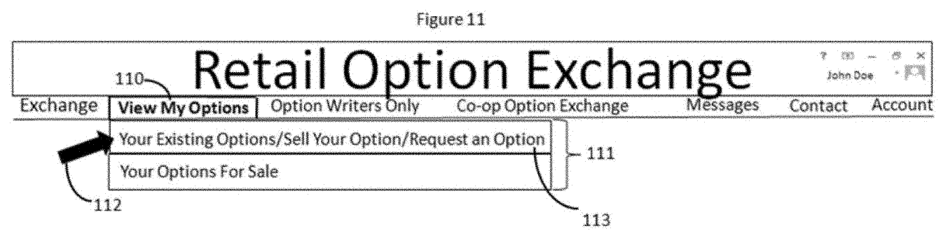

FIG. 11 illustrates the submenu 111 that is displayed by clicking on the upper menu item labeled “View My Options” 110 as described in FIG. 10. In this illustration, an arrow 112 is pointing to the upper submenu item labeled “Your Existing Options/Sell Your Option/Request an Option” 113. Clicking on this upper submenu item 113 causes the computer program to navigate to a page that lists the option holder's existing options, tools for placing an option up for sale on the exchange and tools for requesting an option bid from option writers.

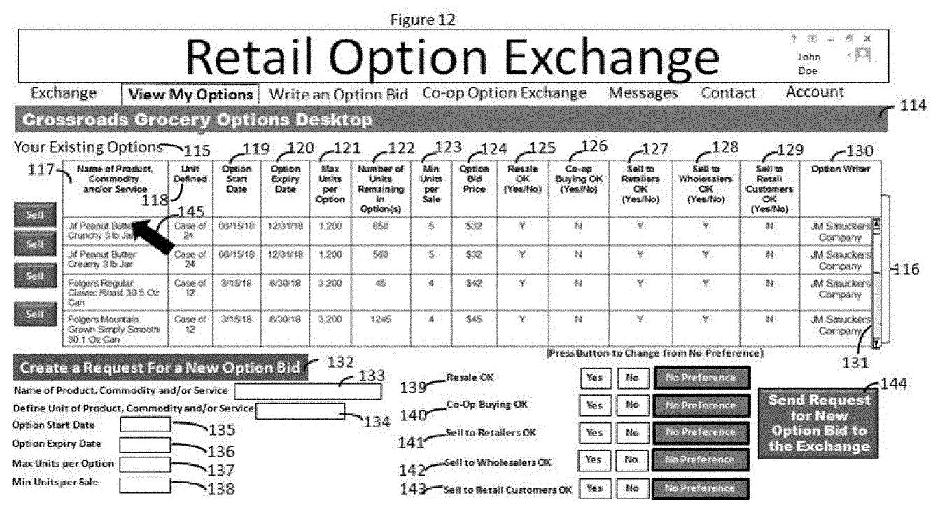

FIG. 12 shows one embodiment of a computer page 114 used by option holders to review their active options. This page may also be used to contact option writers of the options they own and to request an option bid from option writers on the exchange. On the top of this page, the option holder's existing options are displayed 115 in a table 116. The following are the headings for each column listed from left to right in the table 116: Name of Product, Commodity and/or Service 117, Unit Defined 118, Option Start Date 119, Option Expiry Date 120, Max Units per Option 121, Number of Units Remaining in Options(s) 122, Min Units per Sale 123, Option Bid Price 124, Resale OK (Yes/No) 125, Co-op Buying OK (Yes/No) 126, Sell to Retailers OK (Yes/No) 127, Sell to Wholesalers OK (Yes/No) 128, Sell to Retail Customers OK 129 (Yes/No) and Option Writer 130. On the right side of the table 116, is a scroll bar 131 that enables viewing of other existing options that are not currently displayed.

FIG. 12 also shows a section of the page used by an option holder to create a request for a new option bid 132. In this section, a user types in the name of the product and/or service in a data entry box labeled “Name of Product and/or Service” 133. A user types in the description of the unit of product, commodity, and/or service into the data entry box labeled “Define Unit of Product, Commodity and/or Service” 134. Other data entries include an Option Start Date 135, an Option Expiry Date 136, Max Units per Option 137 and Min Units per Sale 138. A column of Yes/No/No Preference toggle switches, with the switches set to “No Preference” by default. These toggle switches are used to indicate if Resale OK 139 if Co-op buying OK 140, if Sell to Retailers OK 141, if Sell to Wholesalers OK 142, and/or if Sell to Retail Customers OK 143. After the person completes their request for an option bid, they may post it on the exchange by pressing an action button labeled “Send Request for New Option Bid to the Exchange” 144.

In FIG. 12, an arrow 145 illustrates how an option holder may select a call option to bring up a pop-up box that contains an option writer's contact information. An option holder may obtain this information by clicking on a product and/or service name in the column labeled “Name of Product, Commodity and/or Service” 117 in the table 116 that displays their existing options.

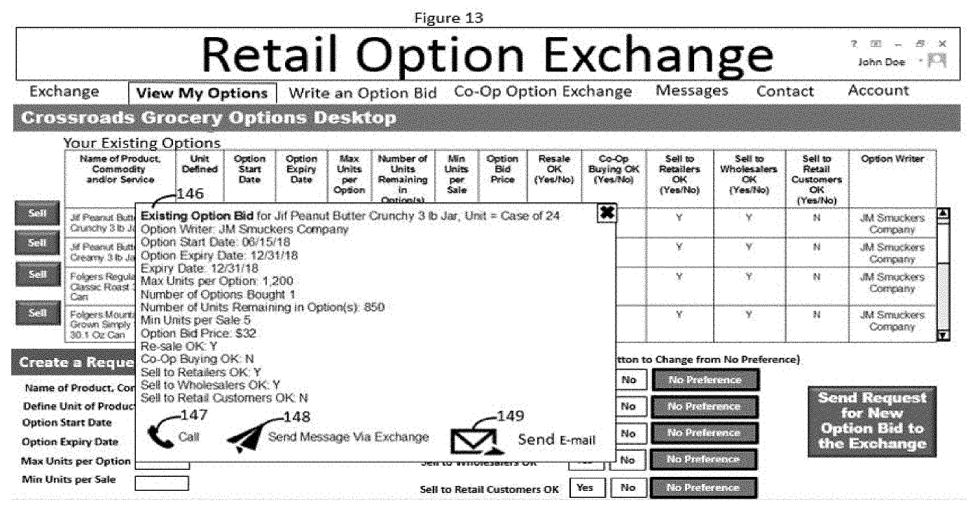

FIG. 13 shows one embodiment of a pop-up box 146 that displays contact information for an option writer whenever a user selects from their list of existing options as described in FIG. 6. At the top of this pop-up box 146, is a summary of the option. A user can point and select a phone icon 147 to obtain the phone number and call an option holder. Alternatively, the user can press a paper airplane icon 148 to send an internal message via Exchange. The option writer can also press an e-mail icon 149 to initiate creation and/or sending an e-mail message.

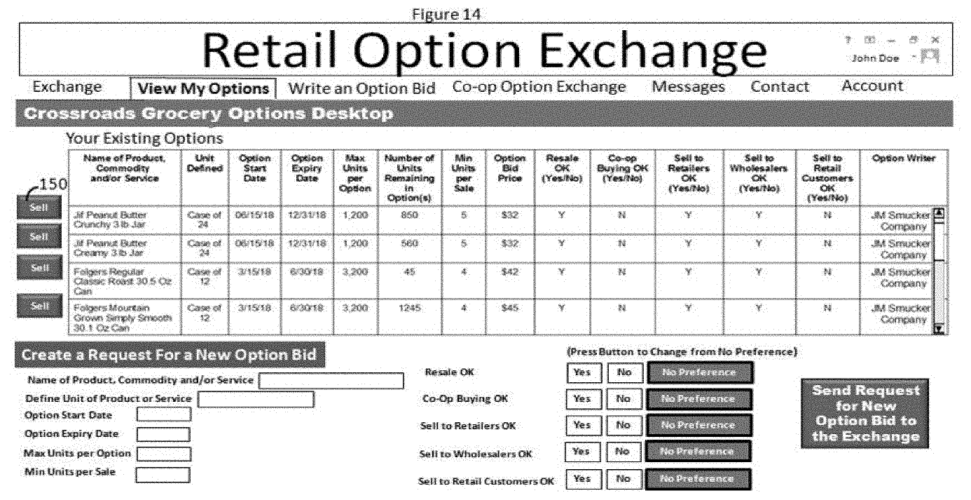

FIG. 14 demonstrates one embodiment of how an option holder initiates the sale of an existing option by activating an action button labeled “Sell” 150 located to the left of one of their active options.

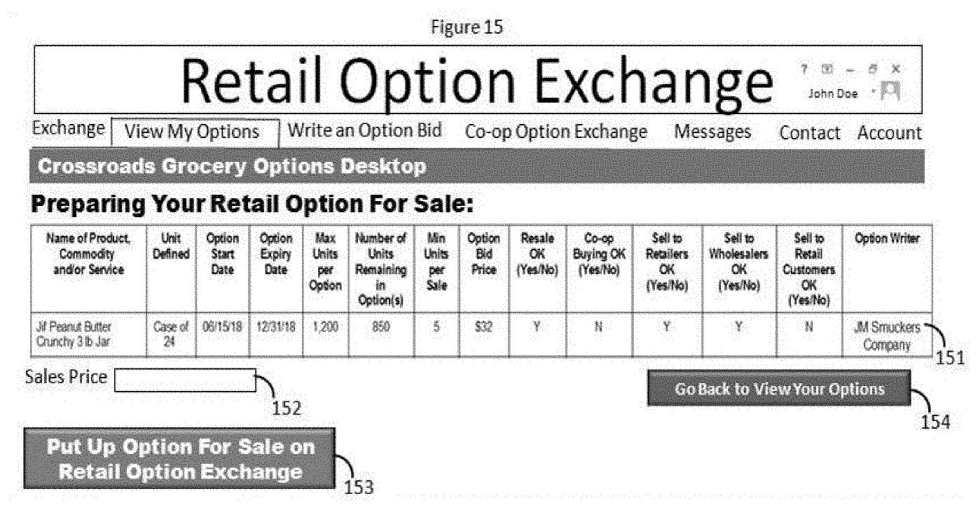

FIG. 15 shows one embodiment of a page used by an option holder to prepare an existing option (e.g., active option) selected in FIG. 14 for sale on an exchange (e.g., the Retail Options Exchange). At the top of this page are a summary of an option contract 151 and a data entry box for entering a sales price 152. An action button labeled “Put up Option for Sale on Retail Options Exchange” 153 may be used to post the option for sale on the exchange. An option holder cannot utilize an option while it is posted for sale on the exchange. An action button labeled “Go Back to View Your Options” 154 may be used to navigate to the page described in FIG. 12.

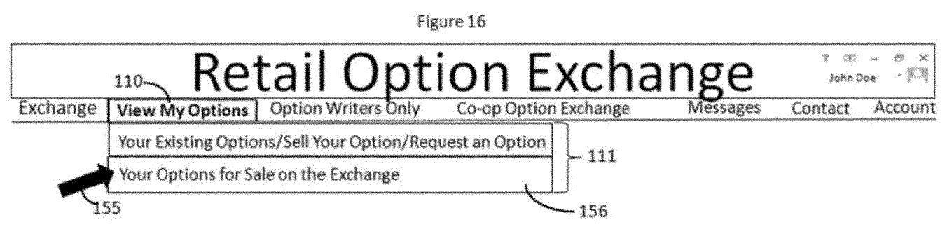

FIG. 16 illustrates the submenu 111 that is displayed by clicking on the upper menu item labeled “View My Options” 110 as described in FIG. 10. In this illustration, an arrow 155 is pointing to the lower submenu item labeled “Your Options for Sale on the Exchange” 156. Clicking on this lower submenu item 156, causes the computer program to navigate to a page that lists the option holder's options that are for sale on the exchange.

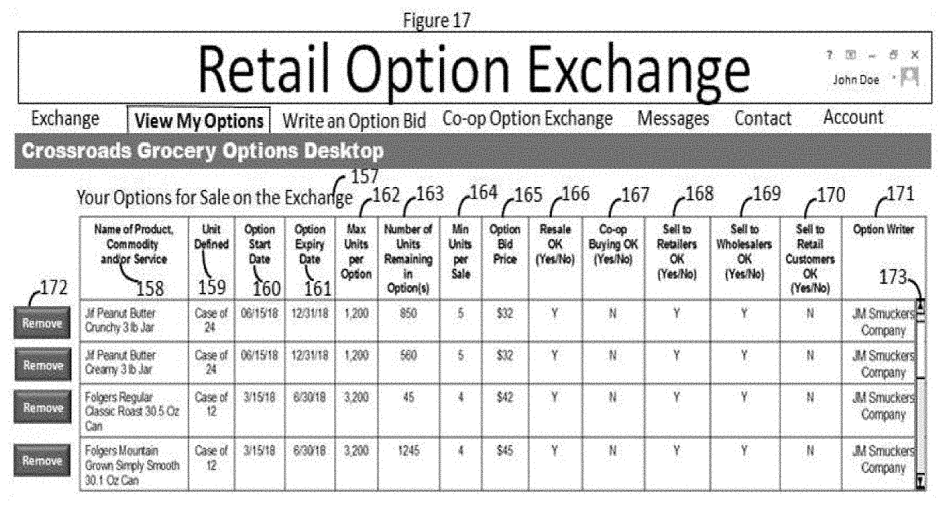

FIG. 17 shows one embodiment of a page for reviewing the options the option holder has for sale on the exchange. In this section, a list of the option holder's options for sale on the exchange is displayed in a table labeled “Your Options for Sale on the Exchange” 157. The following are the headings for each column listed from left to right in the table 157: Name of Product, Commodity and/or Service 158, Unit Defined 159, Option Start Date 160, Option Expiry Date 161, Max Units per Option 162, Number of Units Remaining in Option(s) 163, Min Units per Sale 164, Option Bid Price 165, Resale OK (Yes/No) 166, Co-op Buying OK (Yes/No) 167, Sell to Retailers OK (Yes/No) 168, Sell to Wholesalers OK (Yes/No) 169, Sell to Retail Customers OK (Yes/No) 170 and Option Writer 171. Action buttons labeled “Remove” 172 are located to the left of the options for sale. These buttons labeled “Remove” 172 are used to remove options from the exchange and return them to the holder's list of active options. On the right side of the table 157, is a scroll bar 173 that enables viewing of the option holder's other options listed for sale on the exchange that are not currently displayed.

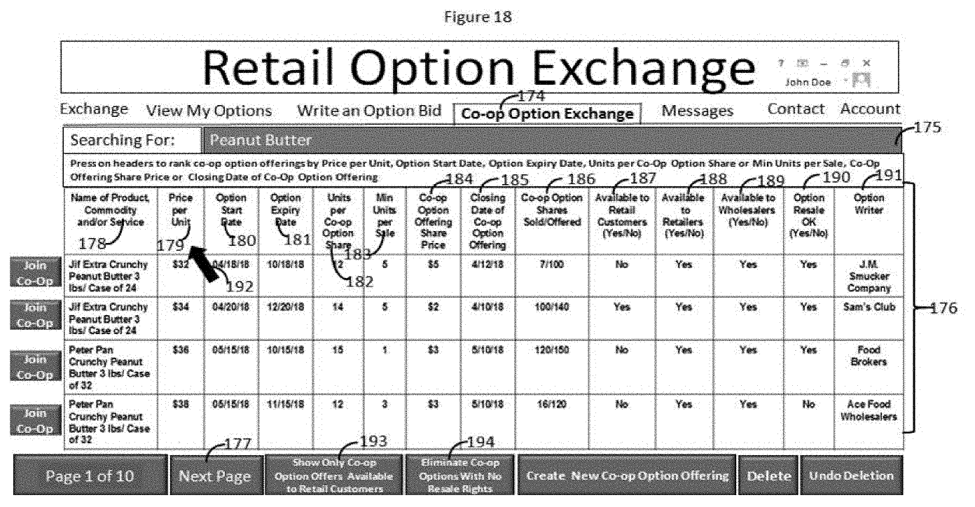

FIG. 18 illustrates one embodiment of a computer page on a trading platform for selecting co-op options offers. A user navigates to this page by selecting “Co-op Option Exchange” 174 from the top menu. On the top of this page is a search box 175 for finding a product, commodity, and/or service. After a user initiates a search, a list of co-op option offers most closely associated with the word or words submitted in the search box are displayed in a table 176. A “Next Page” button 177 listed below the table can be used to view more search results than what is displayed. The following are the headings for each column listed from left to right in the table 176: The Name of the Product, Commodity and/or Service 178, Price per Unit 179, Option Start Date 180, Option Expiry Date 181, Units per Co-Op Option Share 182, Min Units per Sale 183, Co-op Option Offering Share Price 184, Closing Date of Co-op Option Offering 185, Co-op Option Shares Sold/Offered 186, Available to Retail Customers (Yes/No) 187, Available to Retailers (Yes/No) 188, Available to Wholesalers (Yes/No) 189, Option Resale OK (Yes/No) 190, Option Writer 191.

FIG. 18 also illustrates software tools that enable users to quickly rearrange a list of options so that they can analyze and chose an option that will most closely meet their needs. In this illustration, an arrow 192 is pointing the header in the column labeled “Price per Unit” 179. Clicking on this header 179 may cause the co-op option share offerings listed in the table 176 to be ranked from lowest to highest with regards to the price per unit. When the user clicks on the header labeled “Option Start Date” 180, the co-op option share offerings listed in the table 176 are ranked from soonest to latest according to start date. Co-op option share offerings in the table 176 can be ranked from latest to soonest regarding expiry date, by clicking on the header labeled “Option Expiry Date” 181. The user can rank co-op option share offers from most to least number of units a seller can purchase with an option share by clicking on the header labeled “Units per Co-Op Option Share” 182. To rank the co-op option share offerings from least to the most number of minimal units required per sale can be accomplished by clicking on the header labeled “Min Units per Sale” 183. If a user clicks on the action button labeled “Show Only Co-Op Options Offers Available to Retail Customers” 193, only co-op call option offerings that enable purchase and/or use by retail customers may be displayed. Clicking on the choice box labeled “Eliminate Options with No Resale Rights” 194 may remove co-op option offers that don't enable resale.

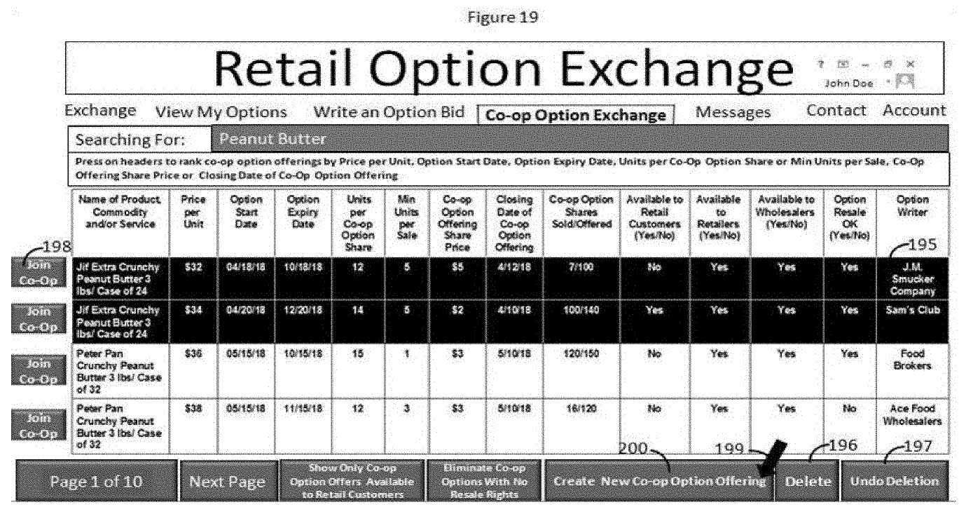

FIG. 19 illustrates one embodiment of highlighting co-op option offerings 195 by pressing the left mouse button on a conventional computer screen or pressing with a finger on a touchscreen while swiping from top to bottom and left to right in the table listing call options. A user can delete highlighted material by pressing a “Delete” key 196. A button labeled “Undo Deletion” 197 is available to undo deletions. When a user clicks on an action button labeled “Join Co-Op” 198 positioned to the left of an option choice, it starts the process of joining the co-op option offering and goes to the checkout page for confirmation of joining the co-op option offering and collecting earnest money. In FIG. 12, an arrow 199 is pointing to a button labeled “Create New Co-op Option Offering” 200. When a user uses a mouse or a finger to point and select this button 200, it brings up a new page for creating a new co-op option offering.

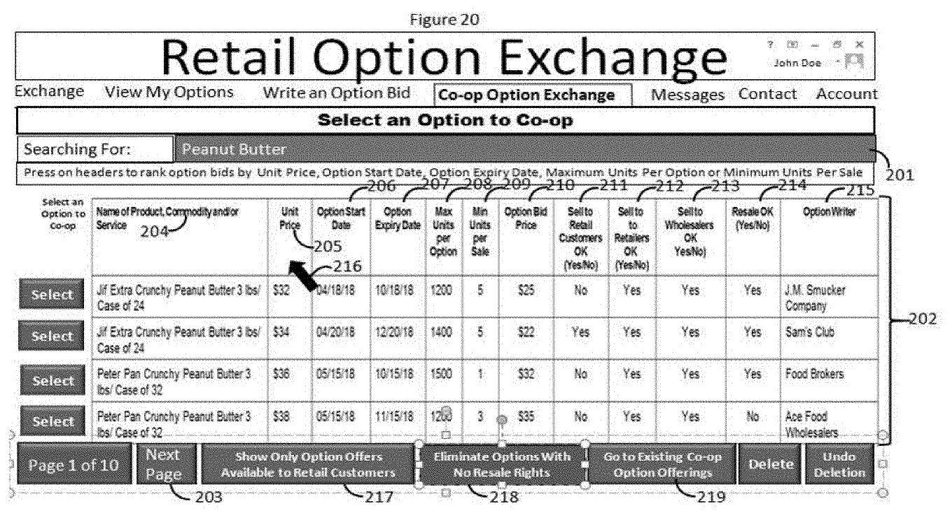

FIG. 20 shows one embodiment of a page that is displayed when a user clicks on the action button labeled “Create New Co-op Option Offering” 200 on the page described in FIG. 19. On the top of this page is a search box 201 for finding a product, commodity, and/or service. A list of option bids most closely associated with the word or words submitted in the search box is displayed in a table 202 after a user initiates a search. A “Next Page” button 203 can be used to view more search results than what is displayed. The following are the headings for each column listed from left to right in the table 201: The Name of the Product, Commodity and/or Service 204, Unit Price 205, Option Start Date 206, Option Expiry Date 207, Max Units per Option 208, Min Units per Sale 209, Option Bid Price 210, Sell to Retail CustomersOK (Yes/No) 211, Sell to Retailers OK (Yes/No) 212, Sell to Wholesalers OK (Yes/No) 213, Resale OK (Yes/No) 214 and Option Writer 215.

FIG. 20 also illustrates software tools that enable users to quickly rearrange a list of options so that they can analyze and chose an existing option that is best for creating a co-op option offering. In this illustration, an arrow 216 is pointing to the header in the column labeled “Unit Price” 205. In response to a user using a mouse or fingertip to point to and select the header labeled “Unit Price” 205, it may cause the options listed in the table 202 to be ranked from lowest to highest with regards to unit price. In response to the user clicking on the header labeled “Option Start Date” 206, the options listed in the table 202 are ranked from soonest to latest according to start date. Options in the table 202 can be ranked from latest to soonest regarding expiry date, by clicking on the header labeled “Option Expiry Date” 207. The user can rank options from most to least number of maximum units a seller can purchase with an option by clicking on the header labeled “Max Units per Option” 208. To rank the options from least to the most number of minimal units required per sale can be accomplished by clicking on the header labeled “Min Units per Sale” 209. If a user clicks on the action button labeled “Show Only Options Available to Retail Customers” 217, only options that enable purchase and use by retail customers are displayed. Clicking on the choice box labeled “Eliminate Options with No Resale Rights” 218 may remove co-op option offers that don't enable resale.

FIG. 20, shows a button labeled “Go to Existing Co-Op Option Offerings” 219. Pointing to and selecting this button 219 may bring the user to the page illustrated in FIG. 18.

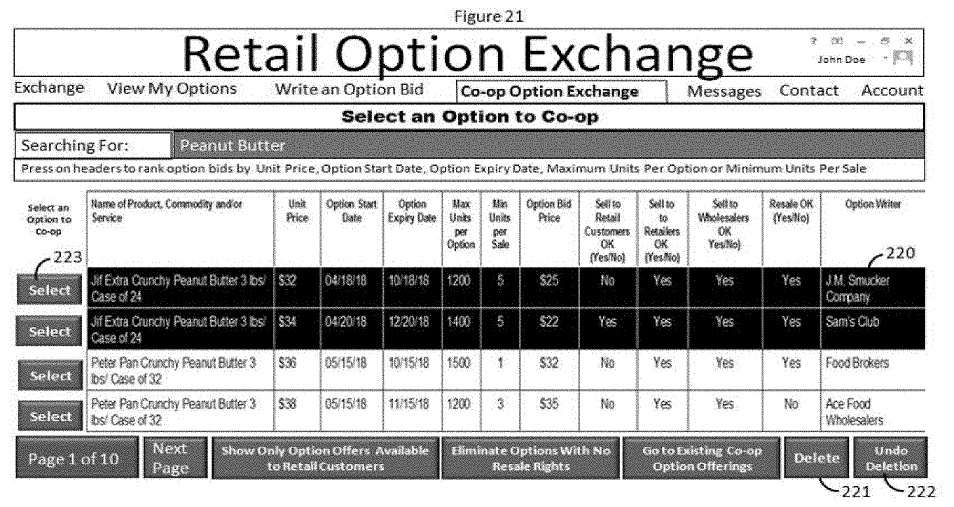

FIG. 21 illustrates one embodiment of highlighting options by pressing the left mouse button on a conventional computer screen or pressing with a finger on a touchscreen while swiping from top to bottom and left to right on the table. A user can delete the highlighted material 220 by pressing a “Delete” key 221. A button labeled “Undo Deletion” 222 is available to undo deletions. In response to a user clicking on an action button labeled “Select” 223 positioned to the left of an option choice, it may be selected for creating a co-op option offering and may go to a new page for creating it.

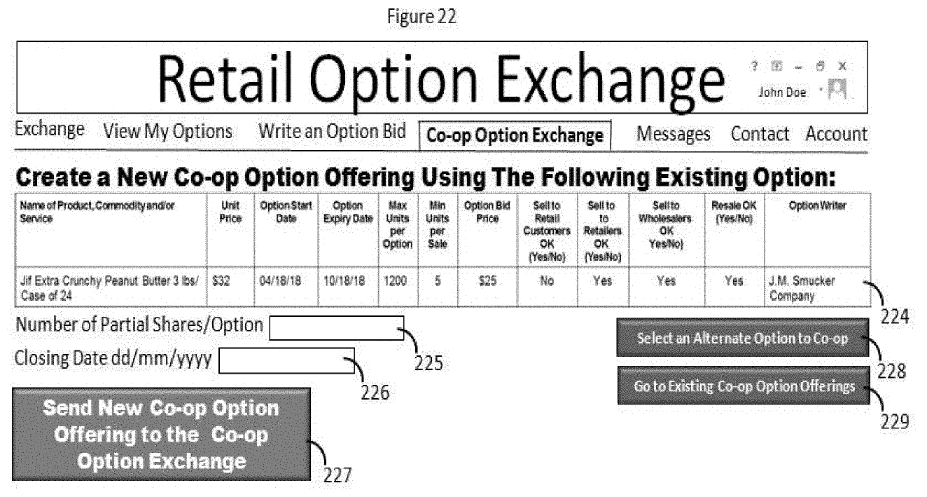

FIG. 22 illustrates one embodiment of a page for creating a new co-op option offering. At the top of the page is an existing option 224 selected on the page described in FIG. 21. On this page, the person creating a new co-op option offering types in a number in a data entry box labeled “Number of Partial Shares/Option” 225 to indicate how they want to fractionate the retail call option that is the basis of the co-op option offering. The originator of a new co-op option offering may also type in the closing date of the co-op option offering in a data entry box labeled “Closing Date” 226. After indicating how to divide the option into shares and the closing date, the user points to and selects a button labeled “Send New Co-op Option Offering to the Co-op Option Exchange” 227 to complete the process. An action button labeled “Select an Alternate Option to Co-op” 228 navigates to the page described in FIG. 21 when selected. An action button labeled “Go to Existing Co-op Option Offerings” 229 navigates to the page described in FIG. 18 when selected.

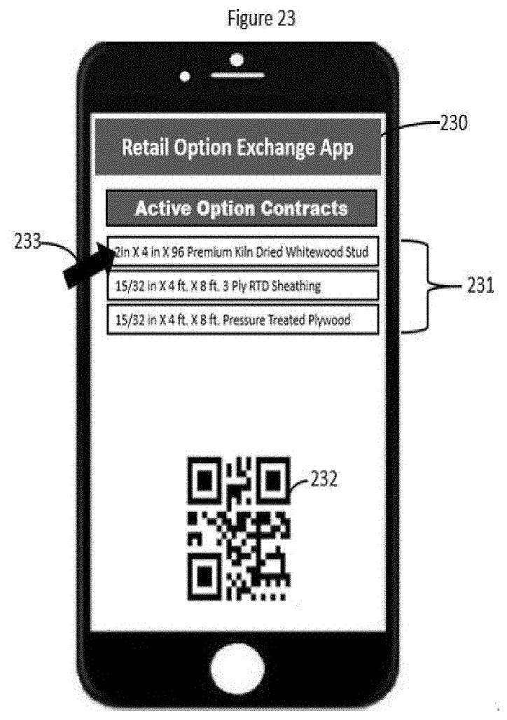

FIG. 23 illustrates one embodiment of an options exchange app 230 that may be called the “Retail Option Exchange App.” on a cell phone for exercising and/or fulfilling call option contracts at point-of-sale systems. In the top portion of the display may be a list of the user's active call option contracts 231. Below the list of active options 231, may be a unique OR code and/or barcode 232. A retailer's point-of-sale system may read this unique OR code and/or barcode 232 to identify a buyer. After the buyer is identified, the point-of-sale system may look up any applicable retail option contracts that would apply to items entered into the system. If an option holder elected for automatic exercise and/or fulfillment of retail call options, the point-of-sale system may automatically adjust the price for any applicable purchases according to the agreements in the option contracts if the seller's prices are higher than the specified prices in the call options.

In FIG. 23, an arrow 233 is pointing to a name of a product and/or service to select one of the existing options 231 listed in the exchange app 230. In response to a user using their finger to point and select an existing option 231, it may bring up another page that displays a summary of the call option and function keys.

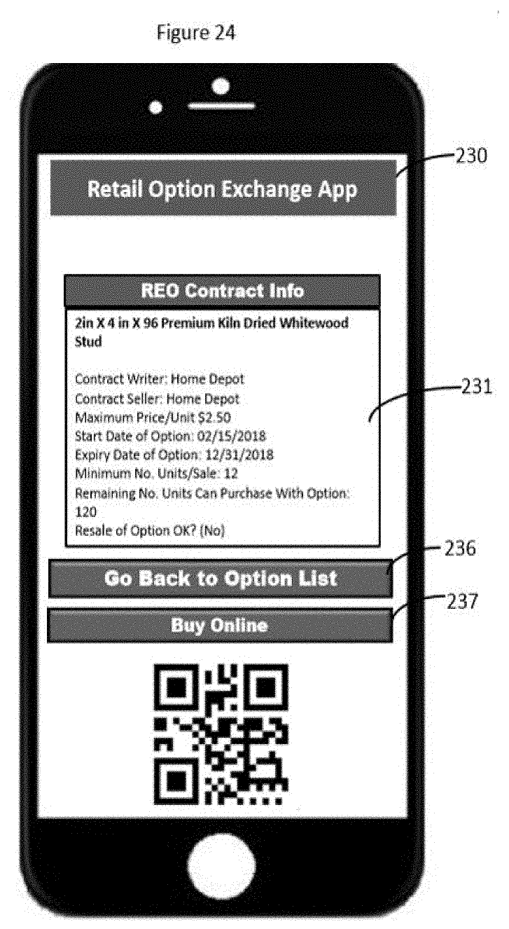

FIG. 24 shows one embodiment of a screen labeled “REO Contract Info” 234 in the Retail Option Exchange App 230 that appears after a user selects one of their active call options 231 as described in FIG. 23. On this screen may be displayed a summary of existing call option 235 selected in FIG. 23. Below the option summary may be two function keys. A top key labeled “Go Back to Option List” 236 may be for navigating back to the screen described in FIG. 16. A bottom key labeled “Buy Online” 237 may take the user to the option writer's e-commerce website to make a purchase and/or to exercise and/or have their option fulfilled.

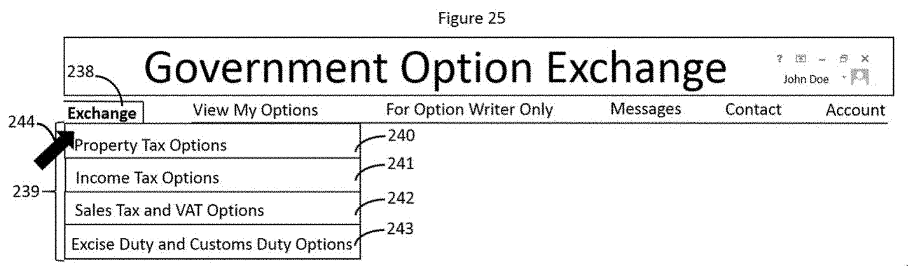

FIG. 25 shows one embodiment of a computer home page for a membership website that may be used for writing and/or selling government-sponsored call options. A user may select “Exchange” 238 in an upper menu to initiate a search for government-sponsored options. Selecting “Exchange” 238 may display a submenu 239 for selecting one of four different types of government-sponsored options. In this submenu, may be listed from top to bottom, are Property Tax Options 240, Income Tax Options 241, Sales Tax and VAT Options 242, and Excise Duty and Customs Duty Options 243. In response to a user selecting one of these option choices as indicated by an arrow 244 in this submenu, the program may navigate to a page for initiating a search for that type of government-sponsored call option contract.

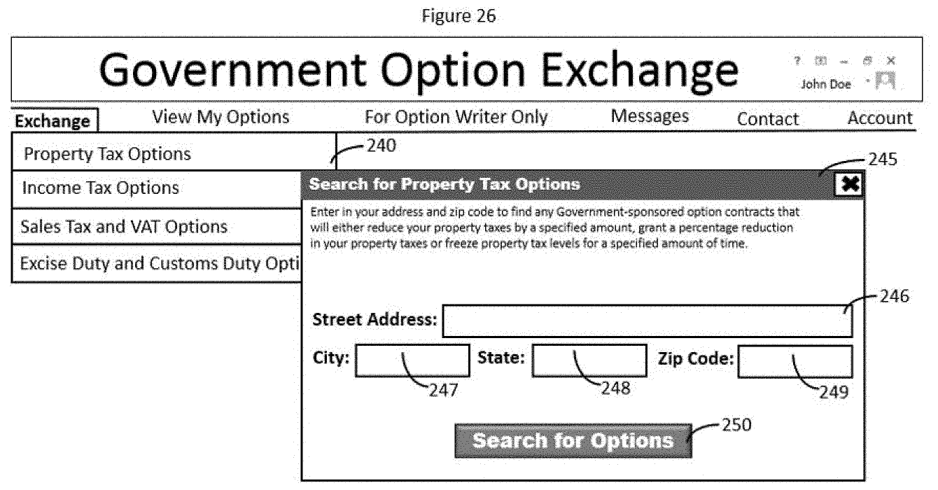

FIG. 26 shows one embodiment of a pop-up box 245 that is displayed after the user selects the submenu labeled “Property Tax Options” 240 as described in FIG. 25. Selection “Property Tax Options” 240 may initiate a search for government-sponsored options that specify a property tax rate for a specified amount of time. To begin a search, a user may enter in their address information by filling in data entry boxes labeled “Street Address” 246, “City” 247, “State” 248 and “Zip Code” 249. After entering in their address, a user may initiate a search for options by pressing the action button labeled “Search for Options” 250.

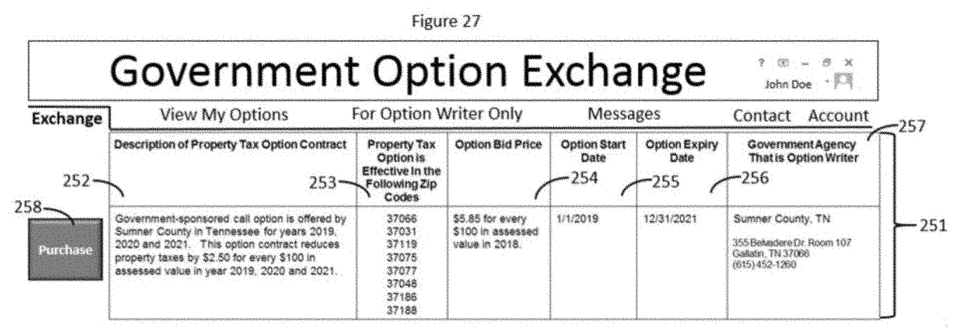

FIG. 27 shows one embodiment of an example of a web page for displaying and/or purchasing government-sponsored options regarding property taxes. Options available for the address entered in pop-up box 245 illustrated in FIG. 26 are listed in a table 251. The following are the headings for each column listed from left to right in the table 251: Description of Property Tax Option Contract 252, Property Tax Options is Effective in the Following Zip Codes 253, Option Bid Price 254, Option Start Date 255, Option Expiry Date 256, and Government Agency That is Option Writer 257. In response to a user clicking on an action button labeled “Purchase” 258 positioned to the left of an option choice, it starts the purchase process and/or navigates to a checkout page for confirmation.

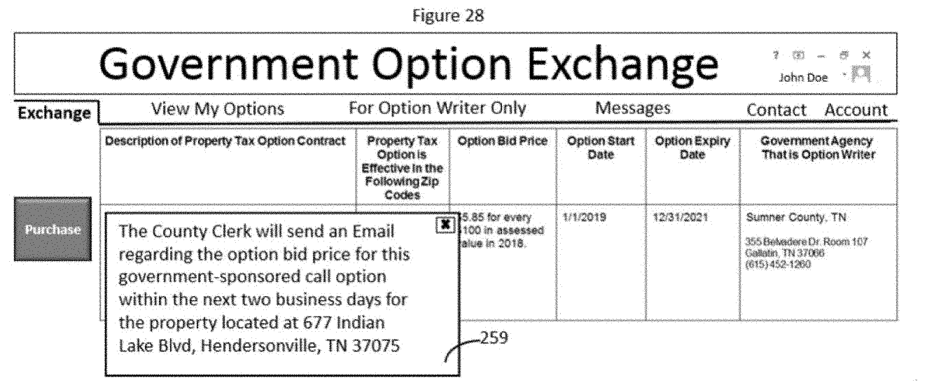

FIG. 28 shows one embodiment of an example of a pop-up box 259 that may be displayed after a user initiates a purchase of a property tax option as illustrated in FIG. 27. In this example, determining a cost of the option bid may be complicated. In this example, a message in the pop-up box 259 states that the user may receive an option bid price from a County Clerk by email within two business days. In this follow-up email, there may be a link for navigating to the page illustrated in FIG. 28 with an actual option price already entered.

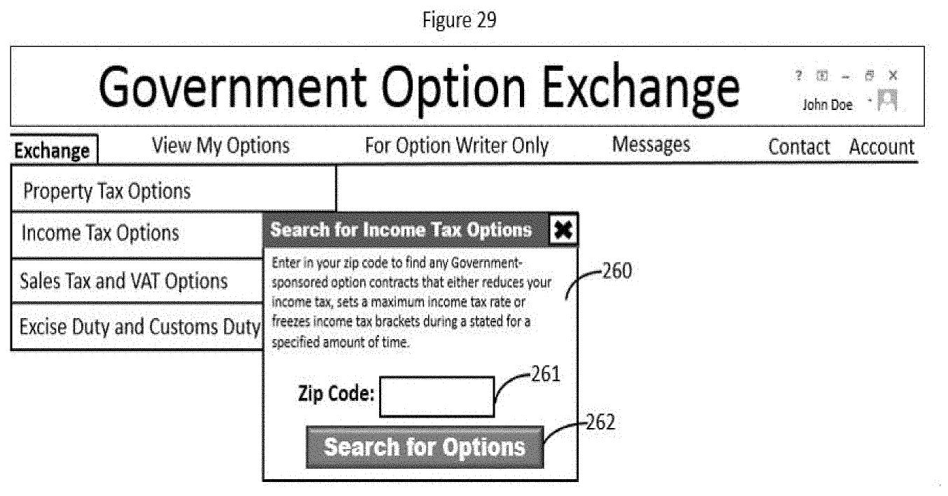

FIG. 29 shows one embodiment of a pop-up box 260 for initiating a search for government-sponsored options that specify an income tax rate for a specified amount of time. To begin a search, a user may enter their zip code in a data entry box labeled “Zip Code” 261. After entering in an address, the user may initiate a search for options by pressing an action button labeled “Search for Options” 262.

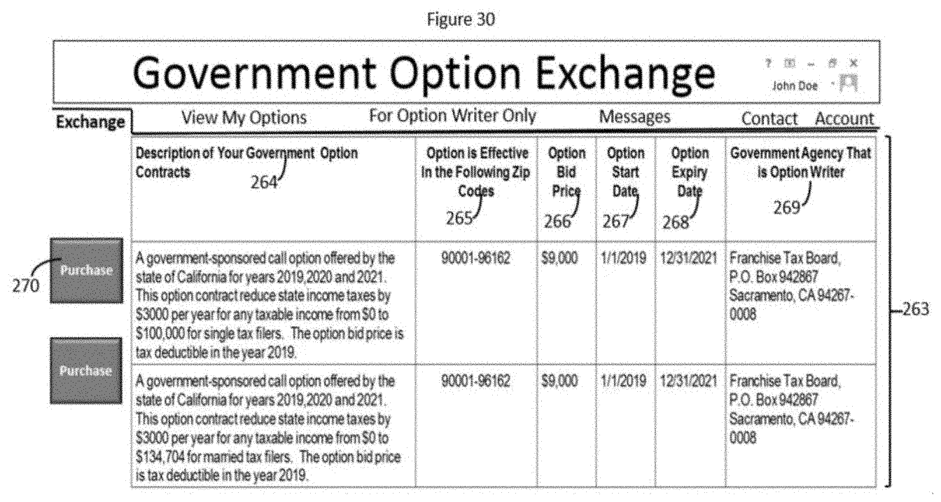

FIG. 30 shows one embodiment of an example of a computer page that displays government-sponsored options regarding income taxes. Available options for the zip code entered in the pop-up box 260 illustrated in FIG. 29 may be listed in a table 263. The following are the headings for each column listed from left to right in the table 263: Description of Your Income Tax Option Contracts 264, Option is Effective in the Following Zip Codes 265, Option Bid Price 266, Option Start Date 267, Option Expiry Date 268, and Government Agency That is the Option Writer 269. In response to a user clicking on an action button labeled “Purchase” 270 positioned to the left of an option choice, it starts the purchase process and/or navigates to a checkout page for confirmation.

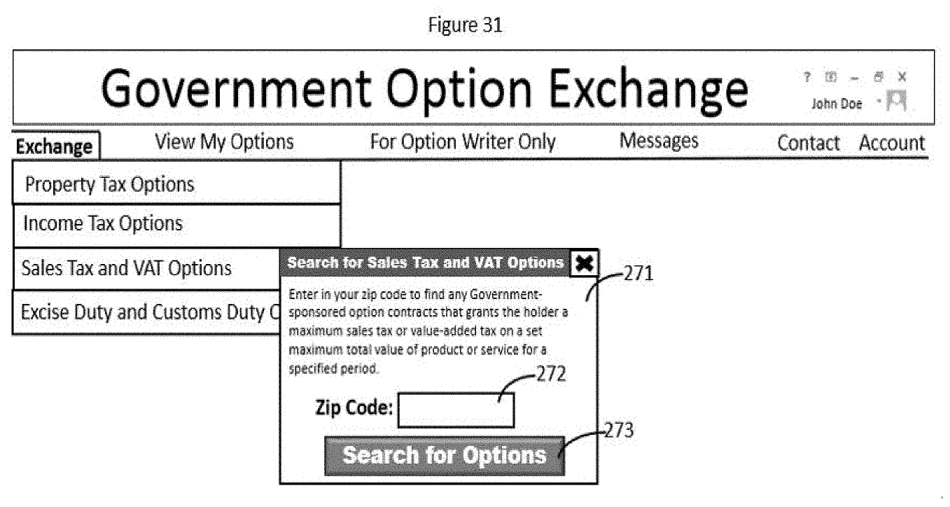

FIG. 31 shows one embodiment of a pop-up box 271 for initiating a search for government-sponsored options that grant the holder a specified sales and/or value-added tax on a specified maximum total value of purchases for a specified amount of time. To begin a search, a user may enter their zip code in a data entry box labeled “Zip Code” 272. After entering in an address, the user may initiate a search for options by pressing an action button labeled “Search for Options” 273.

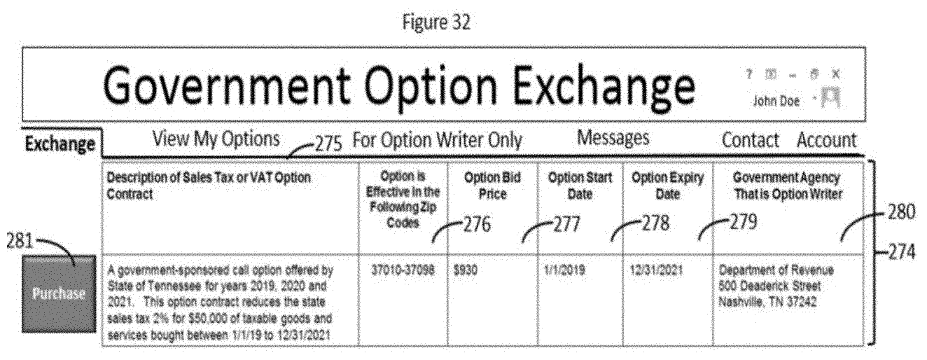

FIG. 32 shows one embodiment of a web page that displays a government-sponsored option regarding sales tax. Available options for the zip code entered in the pop-up box 271 illustrated in FIG. 31 may be listed in a table 274. The following are the headings for each column listed from left to right in the table 274: Description of Sales Tax or VAT Option Contract 275, Option is Effective in the Following Zip Codes 276, Option Bid Price 277, Option Start Date 278, Option Expiry Date 279, and Government Agency That is the Option Writer 280. In response to a user clicking on an action button labeled “Purchase” 281 positioned to the left of an option choice, it starts the purchase process and/or navigates to a checkout page for confirmation.

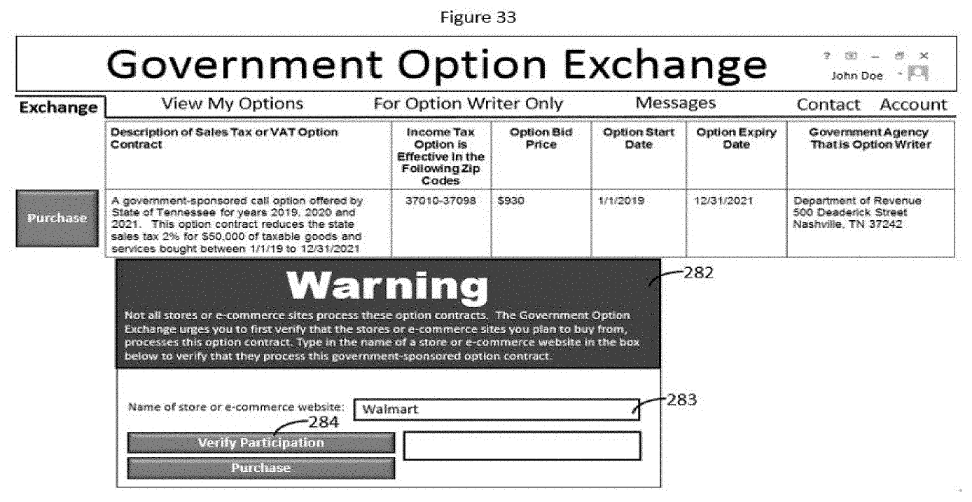

FIG. 33 shows one embodiment of a pop-up box 282 containing a disclaimer in the page that may display government-sponsored options regarding sales or value-added taxes. This prominent disclaimer may warn potential buyers that not every store or e-commerce site process this option contract. It further may urge the user verify that the stores and/or e-commerce sites they plan to buy from, processes the option contract they are thinking of purchasing. It may instruct users to type in the name of a store and/or e-commerce website in the box below and then press a “Verify Participation” button to check that they process this government-sponsored option contract. Below this warning may be a data entry box 283 for putting the name of a store or e-commerce website. An action button labeled “Verify Participation” 284 may be used to initiate verification of the store and/or e-commerce site entered.

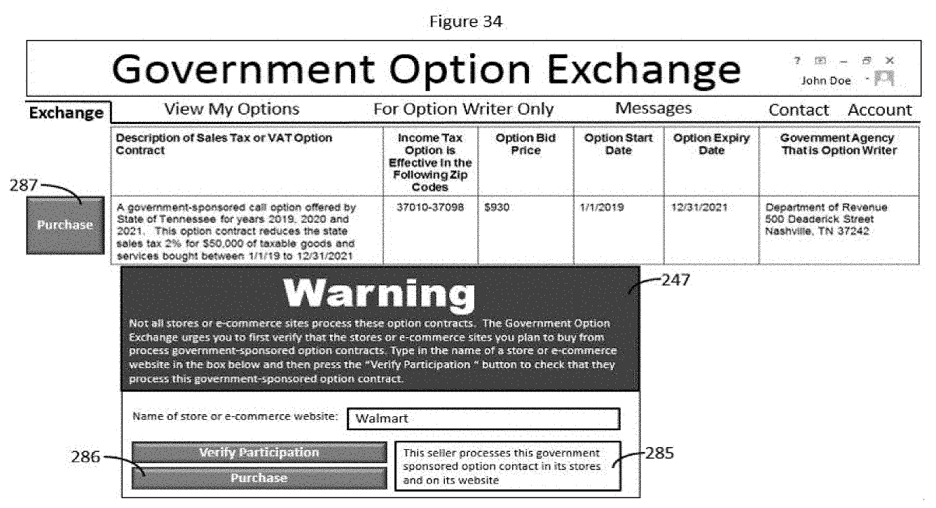

FIG. 34 shows one embodiment of a computer page that may display a government-sponsored option regarding sales taxes. It also may display a pop-up box 247 that contains a disclaimer that was described in FIG. 33. In this example, there is a message 285 that may be used to verify that a store and/or their e-commerce site processes the option that user is considering. This information may be generated by the verification process described In FIG. 33. In response to a user clicking on an action button labeled “Purchase” 286 in the pop-up box 247 or clicking the “Purchase” button 287 a second time, it may start the purchase process and/or navigate to a checkout page for confirmation.

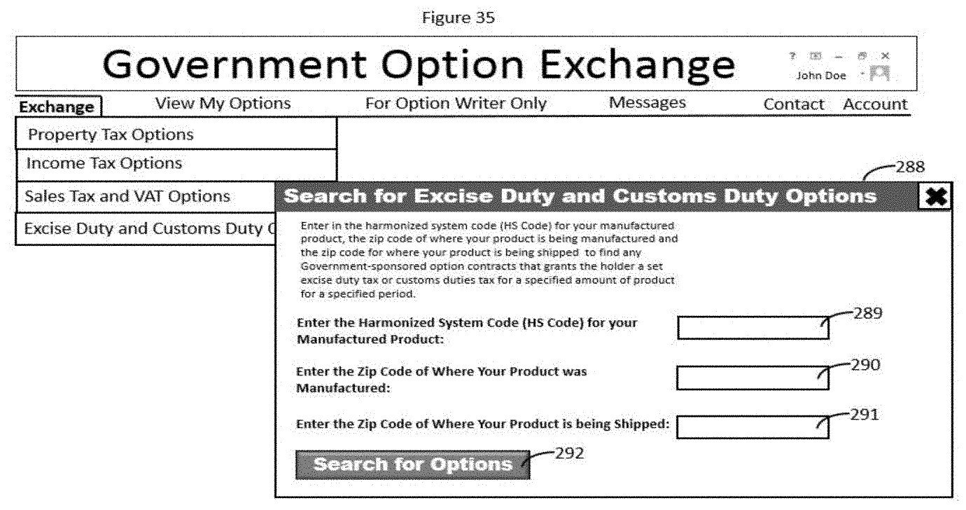

FIG. 35 shows one embodiment of a pop-up box 288 for initiating a search for government-sponsored options that may grant a holder a specified excise duty tax and/or customs duties tax for a specified amount of product for a specified period. In this pop-up box 288, there may be data entry boxes for entering in a Harmonized System Code (HS Code) 289, a zip code where the product was manufactured 290, and/or zip code of where the product is being shipped 291. After entering this information, the user may initiate a search for options by pressing an action button labeled “Search for Options” 292.

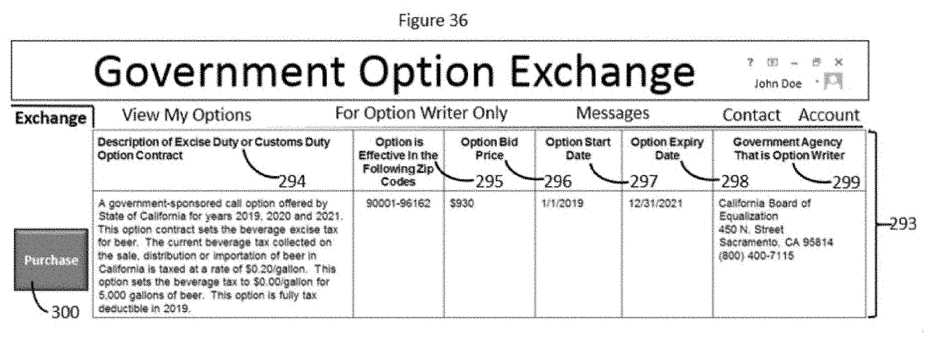

FIG. 36 shows one embodiment of an example of a web page that may display an available option contract regarding an excise duty after a user initiated a search as illustrated in FIG. 35. Available options may be listed in a table 293. The following are the headings for each column listed from left to right in the table 293: Description of Excise Duty or Customs Duty Option Contract 294, Option is Effective in the Following Zip Codes 295, Option Bid Price 296, Option Start Date 297, Option Expiry Date 298, and Government Agency That is the Option Writer 299. In response to a user clicking on an action button labeled “Purchase” 300 positioned to the left of an option choice, it may start a purchase process and/or navigate to a checkout page for confirmation.

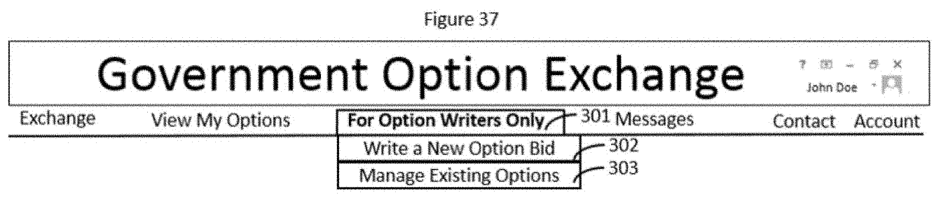

FIG. 37 demonstrates one embodiment of how an option writer may access pages for writing and/or managing government option bids by selecting “For Option Writers Only” 301 in an upper menu of a Government Options Exchange website. Selecting the “Option Writers Only” 301 upper menu item may result in the program displaying a submenu for either going to a page to create a new government-sponsored option bid 302 or to go to a different page to manage existing option contracts 303. If a user is logged on and is not a licensed option writer, and the user selects “For Option Writers Only” 301 on the upper menu, a drop-down menu may not display. Instead, a message stating that this functionality is exclusive to government option writers may be displayed.

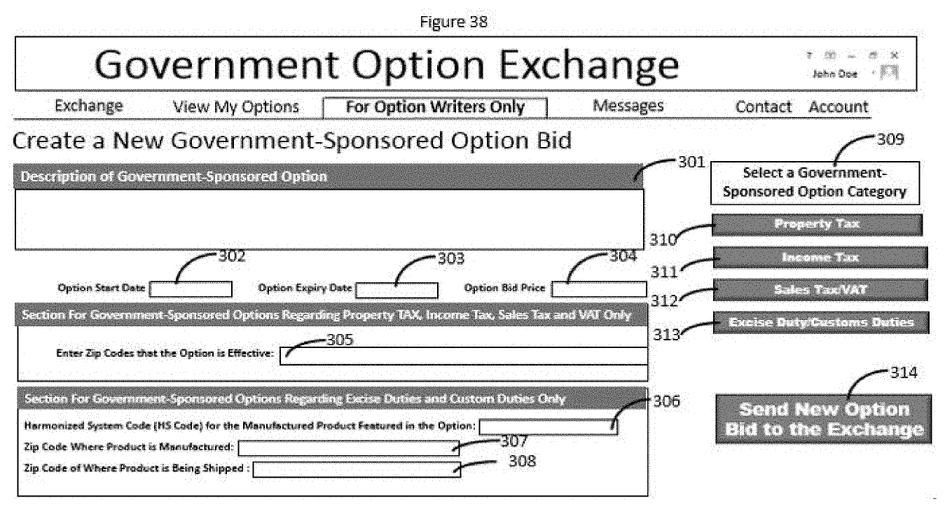

FIG. 38 shows one embodiment of a page used by option writers to write government-sponsored option bids. To create a new option bid, the option writer may enter a description of the option contract in a data entry box 301 provided. Also, the option writer may enter information in data entry boxes labeled “Option Start Date” 302, “Option Expiry Date” 303, and/or “Option Bid Price” 304. If the option is regarding property taxes, income taxes, sales taxes, and/or value-added taxes, the option writer may enter zip codes at locations in which the option is effective 305. If the option is for setting an excise duty or a customs duty, the option writer may fill in data entry boxes labeled “Harmonized System Code (HS Code) for the Manufactured Product Featured in Option” 306, “Zip Code Where Product is Manufactured” 307, and/or Zip Code Where Product is Being Shipped 308. The final step in writing a government-sponsored option may be to select one or more of the four option categories 309: Property Tax 310, Income Tax 311, Sales Tax/VAT 312, and/or Excise Tax/Customs Duties Tax 313. The option writer may send the new option bid to the exchange by pressing an action button labeled “Send New Option Bid to the Exchange” 314.

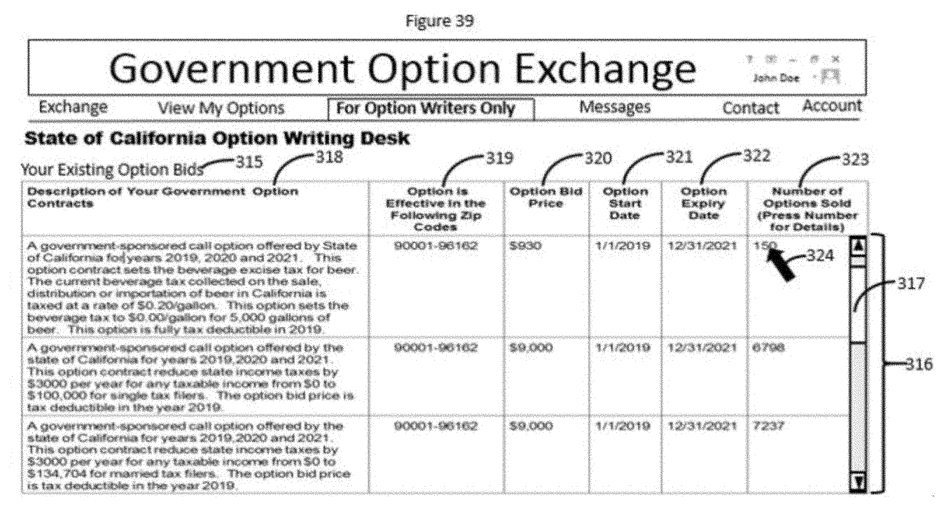

FIG. 39 shows one embodiment of a page an option writer may use for reviewing government-sponsored options contracts they have written 315. Their written options may be arranged in a table 316. A scroll bar 317 may be used to view more options than what is displayed. The following are the headings for each column listed from left to right in the table 316: Description of Your Government Option Contracts 317, Option is Effective in the Following Zip Codes 318, Option Bid Price 319, Option Start Date 320, Option Expiry Date 321, and Number of Options Sold 322. In response to a user selecting a number in the column labeled “Number of Options Sold (Press Number for Details)” 323 as indicated by an arrow 324, a pop-up box may appear that contains information about the option holders of the option described in the row of the number selected.

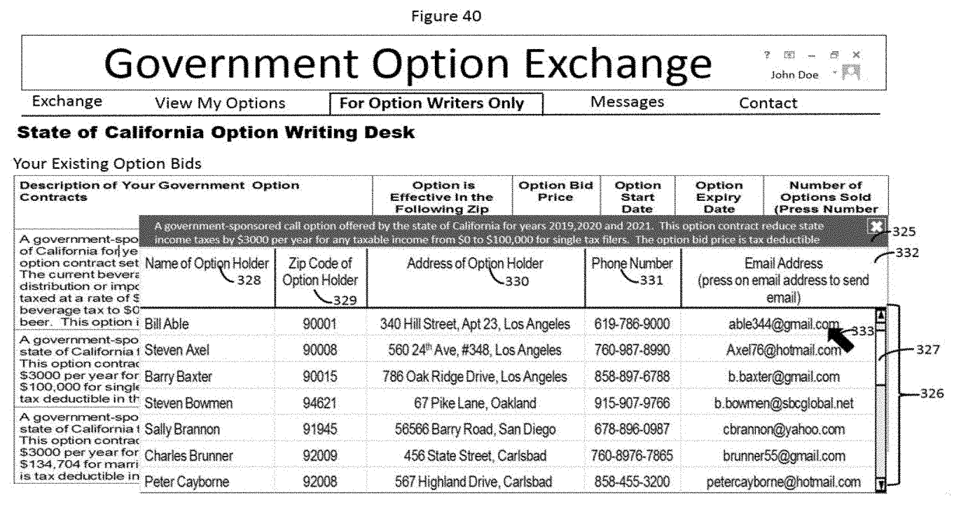

FIG. 40 shows one embodiment of a pop-up box 325 containing option holder information after an option holder makes a selection as described in FIG. 32. A description of a government-sponsored option may be listed at the top of the pop-up box 325 used to review and/or contact the holders of the option contract that was selected. Information about the option holders may be arranged in a table 326. A scroll bar 327 may be used to view more options than what is displayed. The following are the headings for each column listed from left to right in the table 326: Name of the Option Holder 328, Zip Code of the Option Holder 329, Address of the Option Holder 330, Phone Number 331, and Email Address 332. If the option holder clicks on the header labeled “Name of Option Holder” 328 the program may arrange the option holders alphabetically. If the option holder clicks on the header labeled “Zip Code of Option Holder” 329, the program may arrange the option holders from the lowest numbered zip code to the highest. In response to a user selecting an e-mail address as indicated by an arrow 333, it may initiate the creation of an e-mail with the option holder's e-mail address already in it.

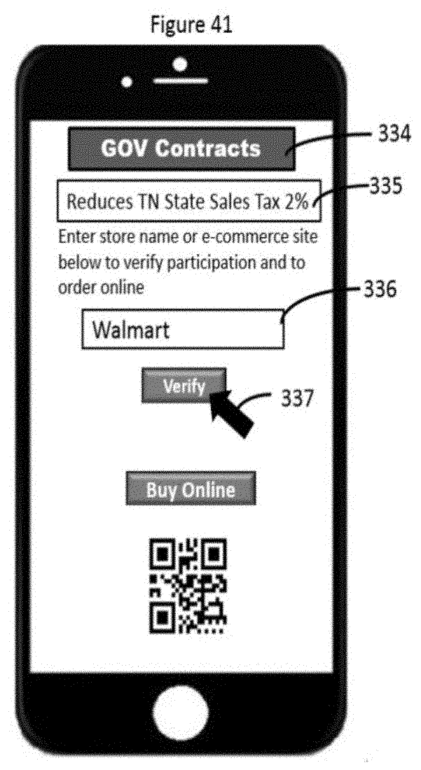

FIG. 41 describes one embodiment of how an app 334 for electronic devices (e.g., smartphones, tablets, etc.) may be used to verify whether stores and/or e-commerce sites process government-sponsored options that set a sales tax and/or value-added tax. A brief description of an option 335 may be listed at the top of the app 334. The user may obtain a more detailed description of the option contract by pressing on a box containing a brief description of the option 335. A user may verify if a store and/or e-commerce site processes the option by entering in the name of a retailer and/or an e-commerce site in a data entry box 336 provided. In response to the user presses an action button labeled “Verify” as indicated by an arrow 337, the app may check if the entered retailer and/or the e-commerce site exercises and/or fulfills this option contract.

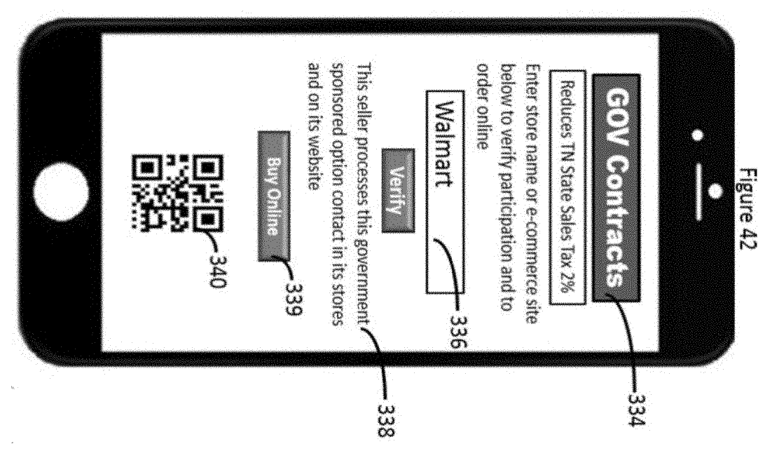

FIG. 42 shows one embodiment of an example of verification 338 that a retailer and/or their e-commerce site may process an option after a user verified this retailer in the data entry box 336 as described in FIG. 34. If the user presses an action button labeled “Buy Online” 339, the program may navigate to an e-commerce website of the retailer listed in the data entry box 336. In response to an option holder using the app 334 to navigate to the option writer's e-commerce website, the app 334 may send information to the e-commerce site that identifies the option holder. After identifying the option holder, the e-commerce site may look for any applicable government-sponsored option that specifies a sales and/or value-added tax rate. If the option holder elected for automatic exercise and/or fulfillment of their government-sponsored call option, the e-commerce site may adjust the sales tax and/or the value-added tax, if the current sales and/or value-added tax is higher than specified tax rates in the option contract. If the option holder did choose automatic exercise and/or fulfillment of their government-sponsored call option, the e-commerce site may go through a verification process before exercising and/or fulfilling the call option.

FIG. 42 includes a OR code and/or barcode 340 on the app 334 for exercising and/or fulfilling government-sponsored options that set a sales tax and/or value-added tax. The retailer's point-of-sale system may read this OR code and/or barcode 340 to identify the buyer and/or to look up any applicable government-sponsored options that would set the sales tax and/or value-added tax on items entered in the point-of-sale system. If the option holder elected for automatic exercise and/or fulfillment of their government-sponsored call option, the point-of-sale system may adjust the sales tax and/or the value-added tax, if the current sales and/or value-added tax is higher than specified tax rates in the option contract. If the option holder did choose automatic exercise and/or fulfillment of their government-sponsored call option, the point-of-sale system may go through a verification process before exercising and/or fulfilling the call option.

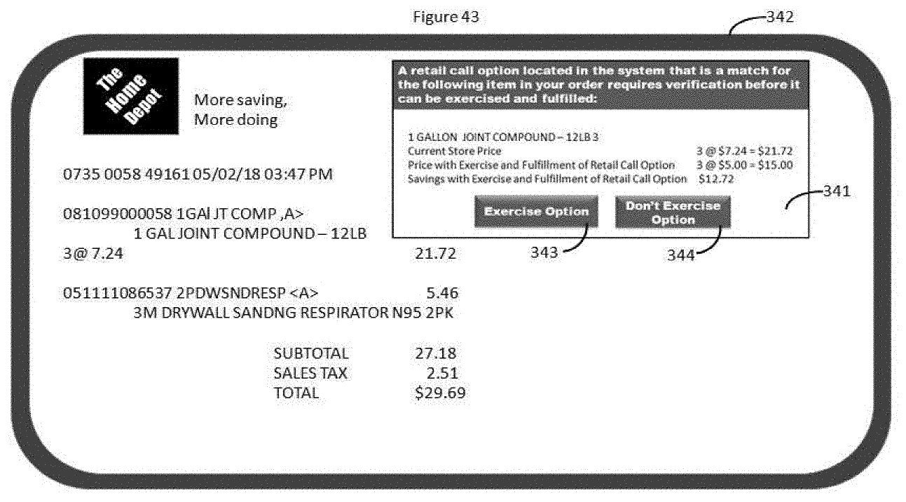

FIG. 43 shows one embodiment that may be used for verification by the option holder before a system exercises and fulfills a retail call option. In this example, a pop-up box 341 is displayed on a screen of a point-of-sale system 342. The header of the pop-up box states that “A retail call option in the system that is a match for the following item in your order requires verification before it can be exercised and fulfilled.” In this embodiment the pop-up box lists the current price, the price after exercise and fulfillment of the call option and the savings with exercise and fulfillment of the retail call option. An action button labeled “Exercise Option” 343 may be used by the option holder to indicate that they want to proceed with exercising and fulfilling the call option. Another action button labeled “Don't Exercise Option” 344 may be used by the option holder to indicate that they don't want to exercise this retail call option for this purchase.

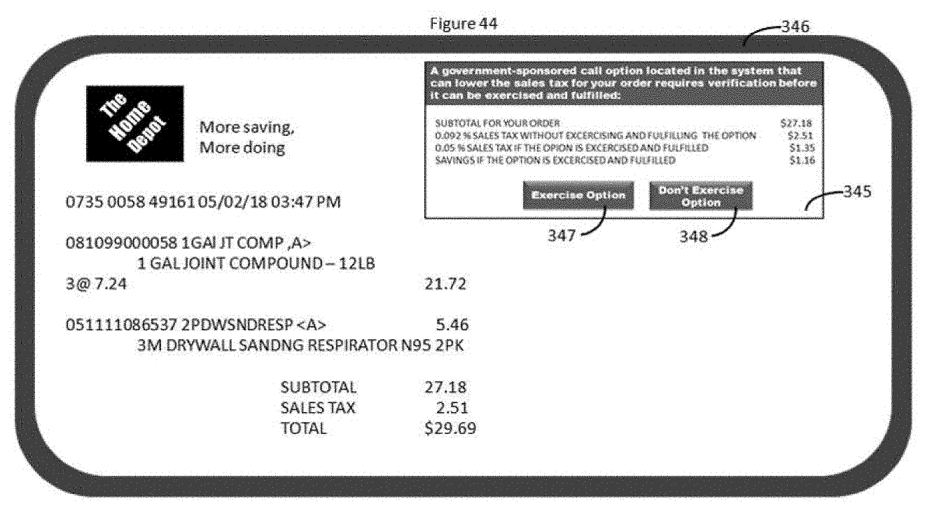

FIG. 44 shows one embodiment that may be used for verification by the option holder before a system exercises and fulfills a government-sponsored call option that specifies a sales tax. In this example, a pop-up box 345 is displayed on a screen of a point-of-sale system 346. The header of the pop-up box states that “A government-sponsored call option in the system that can lower the sales tax for your order requires verification before it can be exercised and fulfilled.” In this embodiment the pop-up box lists the sales tax without exercising and fulfilling the option, the sales tax if the option is exercised and fulfilled and the savings if the option is exercised and fulfilled. An action button labeled “Exercise Option” 347 may be used by the option holder to indicate that they want to proceed with exercising and fulfilling the call option. Another action button labeled “Don't Exercise Option” 348 may be used by the option holder to indicate that they don't want to exercise this government-sponsored call option for this purchase.

As may be appreciated, various embodiments described herein are applied to call options; however, the embodiments described that relate to call options may be similarly use put options as an alternative to call options and/or in addition to call options.

1. A method comprising:
determining a call option for an electronic exchange, wherein the call option provides a buyer of the call option a right to buy an underlying asset that is a product, a commodity, a service, or some combination thereof for a specified price at least one time between a specified start date and a specified expiry date, or a right to receive a specified tax rate at least one time between the specified start date and the specified expiry date;
providing the call option to the electronic exchange to enable the buyer to purchase the call option at an option price, wherein the electronic exchange comprises a website that facilitates the buyer purchasing the call option; and
receiving an indication to exercise the call option, fulfill the call option, or some combination thereof via a point-of-sale system, an e-commerce website, an ordering software, a government agency software, or some combination thereof.

2. The method of claim 1, wherein the for the right to receive the specified tax rate comprises:
a specified property tax rate;
a specified income tax rate;
a specified sales tax rate;
a specified value-added tax rate;
a specified customs duty tax rate;
a specified excise duty tax rate; or
some combination thereof.

3. The method of claim 1, wherein the call option comprises a unit of the underlying asset.

4. The method of claim 1, wherein the call option comprises a maximum number of units of the underlying asset that can be fulfilled with the call option.

5. The method of claim 1, wherein the call option comprises a minimum number of units of the underlying asset that are to be purchased every time the call option is exercised, fulfilled, or a combination thereof.

6. The method of claim 1, wherein the call option comprises an indication indicating whether the call option can be resold to another buyer.

7. The method of claim 2, wherein the specified sales tax rare comprises a maximum total value of purchases that are charged the specified sales tax rate by exercising the call option, fulfilling the call option, or a combination thereof.

8. The method of claim 2, wherein the specified value-added tax rate comprises a maximum total value of purchases that are charged the specified value-added tax rate by exercising the call option, fulfilling the call option, or a combination thereof.

9. The method of claim 2, wherein the specified customs duty tax comprises a specified maximum total number of specified goods that are charged the specified customs duty tax rate by exercising the call option, fulfilling the call option, or a combination thereof.

10. The method of claim 2, wherein the specified excise duty tax comprises a specified maximum total number of specified goods that are charged the specified excise duty tax rate by exercising the call option, fulfilling the call option, or a combination thereof.

11. The method of claim 1, wherein the call option comprises a limit on a use of the call option to entities having retail licenses, wholesale licenses, or a combination thereof.

12. A method comprising:
selecting a call option that permits fractionating of the call option into shares on an electronic exchange, wherein the call option provides a buyer of the call option a right to buy an underlying asset that is a product, a commodity, a service or some combination thereof for a specified price at least one time between a specified start date and a specified expiry date, or a right to receive a specified tax rate at least one time between the specified start date and the specified expiry date;
defining a division of the call option into call option shares by: specifying a number of the call option shares, defining a divisor that divides the call option into the number of the call option shares, defining a multiplier fraction that divides the call option into the number of the call option shares, or some combination thereof;
calculating an option share price of the call option shares by dividing a price of the call option by the number of the call option shares;
providing the call option shares on the electronic exchange to enable the buyer to purchase the call option shares at the option share price, wherein the electronic exchange comprises a website that facilitates the buyer purchasing the call option shares;
enabling purchase of the call option in response to sufficient capital being raised through a sale of the call option shares to purchase the call option;
fractionating the call option into the call option shares;
transferring ownership of the call option shares to buyers of the call option shares; and
receiving an indication to exercise the call option shares, fulfill the call option shares, or some combination thereof via a point-of-sale system, an e-commerce website, an ordering software, a government agency software, or some combination thereof.

13. The method of claim 12, wherein fractionating of the call option into the call option shares comprises:
dividing a maximum number of units of the underlying asset that can be fulfilled with the call option by the number of call option shares.

14. A system comprising:
a processor;
a memory comprising information that identifies a holder of a call option, wherein the call option provides the holder of the call option a right to buy an underlying asset that is a product, a commodity, a service, or some combination thereof for a specified price at least one time between a specified start date and a specified expiry date, or a right to receive a specified tax rate at least one time between the specified start date and the specified expiry date, the memory comprising code executable by the processor, and the code is configured to:
receive the information that identifies the holder of the call option;
verify an identity of the holder of the call option by determining a match between identifying information entered into an input and the information that identifies the holder of the call option;
access the call option of the holder in response to verifying the identity of the holder;
determine whether there is a match between the underlying asset corresponding to the call option and an asset purchased;
determine a tax rate being charged;
initiate exercising the call option, fulfilling the call option, or a combination thereof in response to the specified price of the product, the commodity, the service, or some combination thereof in the call option contract being less than the purchase price; and
initiate exercising the call option, fulfilling the call option, or a combination thereof in response to the specified tax rate being less than the tax rate being charged.

15. The system of claim 14, further comprising a point-of-sale device comprising the processor and the memory.

16. The system of claim 14, wherein the code is further configured to provide an e-commerce site for exercising the call option.

17. The system of claim 14, wherein the code is further configured to provide an ordering software for exercising the call option.

18. The system of claim 14, wherein the code is further configured to provide a government agency software for exercising the call option.

19. The system of claim 14, wherein the identifying information entered into the input may be entered into a point-of-sale system, an e-commerce site, an ordering software, a government agency software, or some combination thereof, and the identifying information entered into the input comprises one or more of:
a manual entry of an alphanumeric code;
information on a magnetic stripe card;
an optical machine-readable representation of data displayed on a card or digital device;
information gained from biometric screening;
a manual entry of a username and password;
identifying information sent by a smartphone app;
a manual entry of a customer's name;
a manual entry of a company's name; and
a manual entry of a customer identification number.

20. The system of claim 14, initiating exercising the call option, fulfilling the call option, or a combination thereof for the underlying asset that is the product, the commodity, the service, or some combination thereof is automatic in response to one or more of:
the holder electing automatic exercise and fulfillment of the call option;
a match is found between the underlying asset corresponding to the call option and the asset purchased;
the specified price for a unit of the underlying asset in the call option is lower than a seller's price for the unit of the underlying asset; and
a date of exercising and fulfilling the call option falls between the specified start date and specified expiry date.

21. The system of claim 14, wherein initiating exercising the call option, fulfilling the call option, or a combination thereof for the underlying asset that is the specified tax rate is automatic in response to one or more of:
the holder electing automatic exercise and fulfillment of the call option;
a match is found between the underlying asset corresponding to the call option and the tax rate being charged;
the specified tax rate in the call option is lower than the tax rate being charged; and
a date of exercising and fulfilling the call option falls between the specified start date and specified expiry date.

22. The system of claim 14, wherein initiating exercising the call option, fulfilling the call option, or a combination thereof for the call option occurs after verification by the holder of the call option in response to the holder electing for verification before exercise the call option, fulfilling the call option, or a combination thereof.
